(19) United States
(12) Patent Application Publication
(10) Pub. No.: US 2025/0035251 A1
(43) Pub. Date: Jan. 30, 2025

(54) VACUUM ADIABATIC BODY, METHOD FOR MANUFACTURING SAME, AND APPARATUS FOR MANUFACTURING SAME

(71) Applicant: LG ELECTRONICS INC., Seoul (KR)

(72) Inventors: Wonyeong JUNG, Seoul (KR); Deokhyun YOUN, Seoul (KR); Jaehwan LEE, Seoul (KR)

(21) Appl. No.: 18/715,372

(22) PCT Filed: Dec. 1, 2022
(86) PCT No.: PCT/KR2022/019388

§ 371 Date: May 31, 2024

(30) Foreign Application Priority Data
Dec. 3, 2021 (KR) 10-2021-0171927

(51) Int. Cl. F16L 59/065; F25D 23/06

(52) U.S. Cl. CPC F16L 59/065; F25D 23/06; F25D 2201/14

(57) ABSTRACT

A vacuum adiabatic body according to the present disclosure may include a first plate; a second plate; and a vacuum space provided between the first plate and the second plate. Optionally, a seal to seal the first and second plate may have improved corrosion resistance.

### TECHNICAL FIELD

The present disclosure relates to a vacuum adiabatic body, a method for manufacturing the same, and an apparatus for manufacturing the same.

### BACKGROUND ART

A vacuum adiabatic wall may be provided to improve adiabatic performance. A device of which at least a portion of an internal space is provided in a vacuum state to achieve an adiabatic effect is referred to as a vacuum adiabatic body.

The applicant has developed a technology to obtain a vacuum adiabatic body that is capable of being used in various devices and home appliances and has disclosed Korean Application Nos. 10-2015-0109724 and 10-2015-0109722 that relate to the vacuum adiabatic body.

In the cited document, a plurality of members are coupled to provide a vacuum space. Specifically, a first plate, a conductive resistance sheet, a side plate, and a second plate are sealed to each other. To seal the coupling portion of each member, a sealing process is performed. A small process error occurring in the sealing process leads to vacuum breakage.

### DISCLOSURE OF INVENTION

### Technical Problem

The present disclosure is to solve the above problems and proposes a vacuum adiabatic body with improved reliability. Various technical problems of the present disclosure are disclosed in detail in the description of the embodiments.

### Solution to Problem

A vacuum adiabatic body according to the present disclosure may include a first plate; a second plate; and a vacuum space provided between the first plate and the second plate. Optionally, the vacuum adiabatic body may include a seal configured to seal the first plate and the second plate so as to provide the vacuum space. Optionally, the seal may be treated to improve corrosion resistance. Optionally, a treatment to improve corrosion resistance may be added after the seal is provided. Optionally, the corrosion resistance may be improved after the seal is sealed.

Optionally, the seal may include at least two of a first material, a second material, and a third material. Optionally, the weight ratio of the first material may be greater than the weight ratio of the second material. Optionally, the strength of the second material may be greater than the strength of the first material. Optionally, corrosion resistance of the second material may be greater than the corrosion resistance of the first material. Optionally, the oxidation degree of the second material may be greater than the oxidation degree of the first material. Optionally, the melting point of the mixture of the first and second materials may be lower than the melting point of the first material. Optionally, the melting point of the first material may be lower than the melting point of the second material. Optionally, the density of the first material may be higher than that of the second material.

Optionally, the seal may include at least two of a first material, a second material, and a third material. Optionally, the seal may include at least one of a first step process, a second step process, and a third step process to improve corrosion resistance.

Optionally, the first step process may include a process of coating the surface of the seal with a material having higher corrosion resistance than the first material. Optionally, the first step process may include at least one of a process in which the weight ratio of the first material decreases and a process in which the weight ratio of the second material increases. Optionally, the first step process may include a process of removing the rough surface of the seal.

Optionally, the first step process may include electrolytic polishing.

Optionally, the seal may include at least one of a first step process, a second step process, and a third step process to improve corrosion resistance. Optionally, in a case of performing the second step process, the second step process may be performed after the seal is sealed.

Optionally, after performing the first step process, a second step process may be performed. Optionally, before performing the third step process, the second step process may be performed.

Optionally, the second step process may include applying a composition to the seal to provide an application portion. Optionally, the composition may be an insulating coating agent of a silicone component or an antirust coating agent of a metal component. Optionally, in the composition, metal powder may be included, or the viscosity of the composition may be 1 cs (centistokes)≤the viscosity of the mixture≤10 cs (centistokes).

Optionally, the application portion may cover the seal. Optionally, the application portion may cover the entire seal. Optionally, the application portion may extend along an extension direction of the seal. Optionally, the thickness of the application portion may be thicker than the first plate. Optionally, the thickness of the application portion may be thinner than the second plate. Optionally, the width W1 of the application portion may be greater than 5 times the width W2 of the seal.

Optionally, the vacuum adiabatic body may optionally include a side plate connecting the first plate and the second plate. At least a portion of the first and second plates and the side plate may be integrally formed, or at least a portion may be sealed with each other. The side plate may include a portion extending in the height direction of the space formed between the first plate and the second plate, or may include a portion extending in the height direction of the vacuum space. The side plate may extend to provide the vacuum space extension portion. The side plate may include a first portion forming the vacuum space and the vacuum space extension portion. The side plate may include a second portion extending from the first portion. A second portion of the side plate may branch a heat conduction path along the side plate. Optionally, the width W1 of the application portion may be smaller than the width of the second portion of the side plate. Optionally, the application portion may cover at least a portion of the cutout in which at least one of the first and second plates is cut. Optionally, the application portion may cover at least a portion of an upper surface of a portion where the first plate and the second plate are spaced apart. Optionally, the application portion may cover at least a portion of a spacer where the first plate and the side plate are spaced apart. Optionally, the application portion may be inserted into the inner space of the spacer where the first plate and the side plate are spaced apart. Optionally, the application portion may extend to at least a portion of the outer surface of the side plate. Optionally, the application portion may cover the cut portion in which the first plate and the side plate are cut.

Optionally, the third step process may be performed after performing at least one of the first step process and the second step process.

The process conditions of the third step process may optionally be a case where the dry humidity is 87% or less as the process conditions of the third step process. Optionally, the process condition of the third step process may be an initial humidity of 87% or less. Optionally, the process conditions of the third step process may be that the initial humidity may be 87% or less and the drying time may be in the range of 6 hours to 48 hours. Optionally, the process conditions of the third step process may be the dry humidity of 60% or less. Optionally, the process conditions of the third step process may be a dry humidity of 60% or less and an initial humidity of 87% or less. Optionally, the process conditions of the third step process may be that the drying humidity of 60% or less and the drying time of the range of 6 hours to 48 hours.

A method for manufacturing a vacuum adiabatic body according to the present disclosure may include: a vacuum adiabatic body component preparation step of manufacturing a component applied to the vacuum adiabatic body; a vacuum adiabatic body component assembly step of assembling the component; a vacuum adiabatic body component sealing step of sealing an outer wall of the vacuum space to block the vacuum space from the external space; a vacuum adiabatic body vacuum exhausting step of exhausting the internal air of the vacuum space; and a device assembly step of providing a device using the vacuum adiabatic body. Optionally, the process of improving the corrosion resistance of the sealed seal may be performed before the device assembling step.

Optionally, the seal may include at least two of a first material, a second material, and a third material. Optionally, the seal may include at least one of a first step process, a second step process, and a third step process to improve corrosion resistance.

The apparatus for manufacturing a vacuum adiabatic body according to the present disclosure may include an electrolytic polishing apparatus. Optionally, the manufacturing device may include a power device that supplies current. Optionally, the manufacturing device may include a first electrode device connected to the power device and supplying power and electrolyte to the vacuum adiabatic body. Optionally, the manufacturing device may include a second electrode device indirectly connected to the first electrode device through the vacuum adiabatic body and connected to the electric power device.

Optionally, the first electrode device may supply the electrolyte to the seal of the vacuum adiabatic body. Optionally, the first electrode device may include a brush for supplying an electrolyte. Optionally, the second electrode device may contact the outside of the seal. Optionally, an adiabatic pad may be provided at an end of the second electrode device.

A vacuum adiabatic body according to the present disclosure may include a first plate; a second plate; and a vacuum space provided between the first plate and the second plate. Optionally, the vacuum adiabatic body may include a seal configured to seal the first plate and the second plate so as to provide the vacuum space. Optionally, at least a portion of the first plate and the second plate includes a first material. Optionally, the seal includes the first material and a second material different from the first material.

Optionally, the second material includes at least two different materials.

Optionally, the vacuum adiabatic body satisfies a condition in which the weight ratio of the first material is greater than the weight ratio of the second material. Optionally, the vacuum adiabatic body satisfies a condition in which the second material includes a component having a greater strength than the first material. Optionally, the vacuum adiabatic body satisfies a condition in which the second material includes a component having greater corrosion resistance than the first material. Optionally, the vacuum adiabatic body satisfies a condition in which the second material includes a component having a greater degree of oxidation than the first material. Optionally, the vacuum adiabatic body satisfies a condition in which the melting point of the mixture of the first and second materials is lower than the melting point of the first material. Optionally, the vacuum adiabatic body satisfies a condition in which the second material includes a portion having a higher melting point than the first material. Optionally, the vacuum adiabatic body satisfies a condition in which the second material includes a portion having a lower density than the first material.

Optionally, a first portion that is at least a portion of a portion of the first plate and the second plate excluding the seal on which the sealing is performed includes the first material and the second material. Optionally, a weight ratio of the second material is provided as A, a weight ratio of the second material in the seal is provided as B, and B and A are different values from each other.

Optionally, B is a value greater than A.

Optionally, the seal includes a portion having a greater strength than the first portion.

Optionally, the seal includes a portion having a greater corrosion resistance than the first portion.

Optionally, the seal includes a portion having a greater degree of oxidation than the first portion.

Optionally, the seal includes a portion formed with an oxide film thicker than the first portion.

Optionally, the seal includes a portion having a lower density than the first portion.

Optionally, the seal includes a portion having a higher rigidity than the first portion.

Optionally, in the seal, the mixture of the first and second materials includes a portion having a lower melting point than the first portion.

Optionally, the seal includes a portion having a higher flexibility than the first portion.

Optionally, the seal includes a portion having a higher melting point than the first portion.

Optionally, the seal includes a portion in which melting occurs later than the first portion in a high-temperature exhaust process for manufacturing the vacuum adiabatic body.

Optionally, the seal is manufactured by the first step process, and the first step process includes a process of coating the second material on the surface of the seal. Optionally, the seal is manufactured by the first step process, and the first step process includes a process of reducing the weight ratio of the first material in the seal. Optionally, the seal is manufactured by the first step process, and the first step process includes a process of increasing the weight ratio of the second material in the seal. Optionally, the seal is manufactured by the first step process, and the first step process includes a process of removing the rough surface from the seal.

Optionally, the first step process includes electrolytic polishing.

Optionally, a first portion that is at least a portion of a portion of the first plate and the second plate excluding the seal on which the sealing is performed includes the first material and the second material. Optionally, the seal includes a material A different from the first material and the second material.

Optionally, the seal includes a portion having a greater strength than the first portion.

Optionally, the seal includes a portion having a greater corrosion resistance than the first portion.

Optionally, the seal includes a portion having a higher adhesive strength or viscosity than the first portion.

Optionally, the seal includes a portion having a higher moisture permeability prevention degree than the first portion.

Optionally, the seal includes a portion having a higher waterproof capacity than the first portion.

Optionally, the material A contains at least one of a silicon component insulation coating agent, a metal component rust prevention coating agent, metal powder, and a material satisfying 1 cs (centistokes)≤the viscosity of A material≤10 cs (centistokes).

Optionally, the seal is manufactured by a second step process, and the second step process includes a process of coating a material A different from the first material and the second material on the surface of the seal. Optionally, the seal is manufactured by a second step process, and the second step process includes a process of reducing the weight ratio of the first material and the second material in the seal. Optionally, the seal is manufactured by a second step process, and the second step process includes a process of increasing the weight ratio of the material A in the seal. Optionally, the seal is manufactured by a second step process, and the second step process includes a process of removing the rough surface from the seal.

Optionally, the second step process includes a process of providing an application portion to the seal.

Optionally, the seal is manufactured by a third step process, and the third step process includes a process in which the seal or the vicinity of the seal is dried. Optionally, the seal is manufactured by a third step process, and the third step process includes a processes in which the seal or the vicinity of the seal is stored within a predetermined humidity range.

Optionally, the predetermined humidity condition satisfies at least one of a dry humidity of 87% or less and an initial humidity of 87% or less.

Optionally, the predetermined humidity condition satisfies at least one of a dry humidity of 87% or less and an initial humidity of 60% or less.

Optionally, the predetermined humidity condition satisfies at least one of a dry humidity of 60% or less and an initial humidity of 87% or less.

Optionally, the predetermined humidity condition satisfies at least one of a dry humidity of 60% or less and an initial humidity of 60% or less.

Optionally, the third step process includes a process of being maintained for 6 hours or more.

Optionally, the third step process includes a process of being maintained for 24 hours or more.

Optionally, the third step process includes a process of being maintained for 48 hours or more.

Optionally, in the third step process, when a is defined as any one of dry humidity and initial humidity and b is defined as the storage time, the ab relational expression satisfies a/b≤14.5 (%/hr).

Optionally, the ab relational expression satisfies a/b≤10 (%/hr).

Optionally, the ab relational expression satisfies a/b≤7.25 (%/hr).

Optionally, in the third step process, when a is defined as any one of dry humidity and initial humidity and b is defined as the drying time, the ab relational expression satisfies a/b≤14.5 (%/hr).

Optionally, the ab relational expression satisfies a/b≤10 (%/hr).

Optionally, the ab relational expression satisfies a/b≤7.25 (%/hr).

Optionally, the seal is manufactured by at least two or more processes, and, the process includes a process A and a process B. Optionally, the process A includes at least one of fusion welding and pressure welding. Optionally, process B includes at least one of a first step process, a second step process, and a third step process. Optionally, the process B simultaneously performs at least two or more of the first step process, the second step process, and the third step process.

Optionally, the first step process includes a process of increasing the strength of the seal. Optionally, the first step process includes a process of increasing the corrosion resistance of the seal. Optionally, the first step process includes a process of increasing the degree of oxidation of the seal. Optionally, the first step process includes a process of forming a thicker oxide film on the seal. Optionally, the first step process includes a process of reducing the density of the seal. Optionally, the first step process includes a process of increasing the rigidity of the seal. Optionally, the first step process includes a process of increasing the flexibility of the seal. Optionally, the first step process includes a process of raising or lowering the melting point of the seal. Optionally, the first step process includes a process of, in the high-temperature exhaust process for manufacturing the vacuum adiabatic body, causing the seal to melt late. Optionally, the first step process includes a process of changing the weight ratio of the composition constituting the material of the seal. Optionally, the first step process includes a process of coating the seal. Optionally, the first step process includes a process of changing the formation of the surface of the seal.

Optionally, the second step process includes a process of increasing the strength of the seal. Optionally, the second step process includes a process of increasing the corrosion resistance of the seal. Optionally, the second step process includes a process of increasing the adhesive strength or viscosity of the seal. Optionally, the second step process includes a process of increasing the moisture permeability prevention degree of the seal. Optionally, the second step process includes a process of increasing the waterproof ability of the seal. Optionally, the second step process includes a process of changing the weight ratio of the composition constituting the material of the seal. Optionally, the second step process includes a process of coating the seal. Optionally, the second step process includes a process of changing the formation of the surface of the seal.

Optionally, the third step process includes a process in which the seal or the vicinity of the seal is dried. Optionally, the third step process includes a process in which the seal or the vicinity of the seal is stored within a predetermined humidity range.

Optionally, the process B is performed after the process A is performed.

Optionally, the process B is performed while the process A is performed.

### Advantageous Effects of Invention

The vacuum adiabatic body according to the present disclosure can maintain a high adiabatic effect for a long time. Various effects of the present disclosure are disclosed in more detail in the description of the embodiments.

### BRIEF DESCRIPTION OF DRAWINGS

FIG. 1 is a perspective view of a refrigerator according to an embodiment.

FIG. 2 is a view schematically illustrating a vacuum adiabatic body used in a body and a door of the refrigerator.

FIG. 3 is a view illustrating an example of a support that maintains a vacuum space.

FIG. 4 is a view for explaining an example of the vacuum with respect to a heat transfer resistor.

FIG. 5 is a graph illustrating results obtained by observing a process of exhausting the inside of the vacuum adiabatic body with a time and pressure when the support is used.

FIG. 6 is a graph illustrating results obtained by comparing a vacuum pressure to gas conductivity.

FIG. 7 is a view illustrating various examples of the vacuum space.

FIG. 8 is a view for explaining another adiabatic body.

FIG. 9 is a view for explaining a heat transfer path between first and second plates having different temperatures.

FIG. 10 is a view for explaining a branch portion on the heat transfer path between first and second plates having different temperatures.

FIG. 11 is a view for explaining a method for manufacturing a vacuum adiabatic body.

FIG. 12 is an enlarged perspective view illustrating an upper side of a corner portion in which a tube is installed in the vacuum adiabatic body.

FIG. 13 is a view for explaining a method of processing a through-hole of the first plate.

FIG. 14 is a cross-sectional view taken along line 1-1′ of (b) of FIG. 12.

FIG. 15 illustrates an example in which a flange extends toward the outside of the vacuum space.

FIGS. 16 to 18 are views for explaining a method for manufacturing a vacuum adiabatic body.

FIG. 19 is a perspective view illustrating a vacuum adiabatic body according to the embodiment.

FIG. 20 is a view illustrating in detail the relationship between the strength reinforcement portion and the seal.

FIG. 21 is a view illustrating an embodiment of another strength reinforcement portion according to the position.

FIG. 22 is a view illustrating an embodiment of another strength reinforcement portion according to the method for providing the strength reinforcement portion.

FIG. 23 is a view for explaining the action of the formed strength reinforcement portion.

FIG. 24 is an enlarged view illustrating a portion of a first plate on which a tube is installed.

FIG. 25 is a cross-sectional perspective view illustrating a state where the vacuum adiabatic body is cut in the thickness direction of the vacuum adiabatic body centering on the strength reinforcement portion.

FIG. 26 is a cross-sectional view illustrating a vacuum adiabatic body for explaining a strength reinforcement portion.

FIG. 27 is a plan view illustrating the vacuum adiabatic body.

FIG. 28 is a view for explaining the entire process of a local electrolytic polishing process.

FIG. 29 is a perspective view illustrating the connection between the first electrode device and the vacuum adiabatic body.

FIG. 30 is a plan view illustrating the connection between the first electrode device and the vacuum adiabatic body.

FIG. 31 is a view for explaining an electrolytic polishing operation.

FIG. 32 is a partial plan view illustrating a vacuum adiabatic body illustrating a second step process of applying a mixture.

### BEST MODE FOR CARRYING OUT THE INVENTION

Hereinafter, specific embodiments will be described in detail with reference to the accompanying drawings. The disclosure may, however, be embodied in many different forms and should not be construed as being limited to the embodiments set forth herein, and a person of ordinary skill in the art, who understands the spirit of the present disclosure, may readily implement other embodiments included within the scope of the same concept by adding, changing, deleting, and adding components; rather, it will be understood that they are also included within the scope of the present disclosure. The present disclosure may have many embodiments in which the idea is implemented, and in each embodiment, any portion may be replaced with a corresponding portion or a portion having a related action according to another embodiment. The present disclosure may be any one of the examples presented below or a combination of two or more examples.

The present disclosure relates to a vacuum adiabatic body including a first plate; a second plate; a vacuum space defined between the first and second plates; and a seal providing the vacuum space that is in a vacuum state. The vacuum space may be a space in a vacuum state provided in an internal space between the first plate and the second plate. The seal may seal the first plate and the second plate to provide the internal space provided in the vacuum state. The vacuum adiabatic body may optionally include a side plate connecting the first plate to the second plate. In the present disclosure, the expression “plate” may mean at least one of the first and second plates or the side plate. At least a portion of the first and second plates and the side plate may be integrally provided, or at least portions may be sealed to each other. Optionally, the vacuum adiabatic body may include a support that maintains the vacuum space. The vacuum adiabatic body may selectively include a thermal insulator that reduces an amount of heat transfer between a first space provided in vicinity of the first plate and a second space provided in vicinity of the second plate or reduces an amount of heat transfer between the first plate and the second plate. Optionally, the vacuum adiabatic body may include a component coupling portion provided on at least a portion of the plate. Optionally, the vacuum adiabatic body may include another adiabatic body. Another adiabatic body may be provided to be connected to the vacuum adiabatic body. Another adiabatic body may be an adiabatic body having a degree of vacuum, which is equal to or different from a degree of vacuum of the vacuum adiabatic body. Another adiabatic body may be an adiabatic body that does not include a degree of vacuum less than that of the vacuum adiabatic body or a portion that is in a vacuum state therein. In this case, it may be advantageous to connect another object to another adiabatic body.

In the present disclosure, a direction along a wall defining the vacuum space may include a longitudinal direction of the vacuum space and a height direction of the vacuum space. The height direction of the vacuum space may be defined as any one direction among virtual lines connecting the first space to the second space to be described later while passing through the vacuum space. The longitudinal direction of the vacuum space may be defined as a direction perpendicular to the set height direction of the vacuum space. In the present disclosure, that an object A is connected to an object B means that at least a portion of the object A and at least a portion of the object B are directly connected to each other, or that at least a portion of the object A and at least a portion of the object B are connected to each other through an intermedium interposed between the objects A and B. The intermedium may be provided on at least one of the object A or the object B. The connection may include that the object A is connected to the intermedium, and the intermedium is connected to the object B. A portion of the intermedium may include a portion connected to either one of the object A and the object B. The other portion of the intermedium may include a portion connected to the other of the object A and the object B. As a modified example, the connection of the object A to the object B may include that the object A and the object B are integrally prepared in a shape connected in the above-described manner. In the present disclosure, an embodiment of the connection may be support, combine, or a seal, which will be described later. In the present disclosure, that the object A is supported by the object B means that the object A is restricted in movement by the object B in one or more of the +X, −X, +Y, −Y, +Z, and −Z axis directions. In the present disclosure, an embodiment of the support may be the combine or seal, which will be described later. In the present disclosure, that the object A is combined with the object B may define that the object A is restricted in movement by the object B in one or more of the X, Y, and Z-axis directions. In the present disclosure, an embodiment of the combining may be the sealing to be described later. In the present disclosure, that the object A is sealed to the object B may define a state in which movement of a fluid is not allowed at the portion at which the object A and the object B are connected. In the present disclosure, one or more objects, i.e., at least a portion of the object A and the object B, may be defined as including a portion of the object A, the whole of the object A, a portion of the object B, the whole of the object B, a portion of the object A and a portion of the object B, a portion of the object A and the whole of the object B, the whole of the object A and a portion of the object B, and the whole of the object A and the whole of the object B. In the present disclosure, that the plate A may be a wall defining the space A may be defined as that at least a portion of the plate A may be a wall defining at least a portion of the space A. That is, at least a portion of the plate A may be a wall forming the space A, or the plate A may be a wall forming at least a portion of the space A. In the present disclosure, a central portion of the object may be defined as a central portion among three divided portions when the object is divided into three sections based on the longitudinal direction of the object. A peripheral portion of the object may be defined as a portion disposed at a left or right side of the central portion among the three divided portions. The peripheral portion of the object may include a surface that is in contact with the central portion and a surface opposite thereto. The opposite side may be defined as a border or edge of the object. Examples of the object may include a vacuum adiabatic body, a plate, a heat transfer resistor, a support, a vacuum space, and various components to be introduced in the present disclosure. In the present disclosure, a degree of heat transfer resistance may indicate a degree to which an object resists heat transfer and may be defined as a value determined by a shape including a thickness of the object, a material of the object, and a processing method of the object. The degree of the heat transfer resistance may be defined as the sum of a degree of conduction resistance, a degree of radiation resistance, and a degree of convection resistance. The vacuum adiabatic body according to the present disclosure may include a heat transfer path defined between spaces having different temperatures, or a heat transfer path defined between plates having different temperatures. For example, the vacuum adiabatic body according to the present disclosure may include a heat transfer path through which cold is transferred from a low-temperature plate to a high-temperature plate. In the present disclosure, when a curved portion includes a first portion extending in a first direction and a second portion extending in a second direction different from the first direction, the curved portion may be defined as a portion that connects the first portion to the second portion (including 90 degrees).

In the present disclosure, the vacuum adiabatic body may optionally include a component coupling portion. The component coupling portion may be defined as a portion provided on the plate to which components are connected to each other. The component connected to the plate may be defined as a penetration portion disposed to pass through at least a portion of the plate and a surface component disposed to be connected to a surface of at least a portion of the plate. At least one of the penetration component or the surface component may be connected to the component coupling portion. The penetration component may be a component that defines a path through which a fluid (electricity, refrigerant, water, air, etc.) passes mainly. In the present disclosure, the fluid is defined as any kind of flowing material. The fluid includes moving solids, liquids, gases, and electricity. For example, the component may be a component that defines a path through which a refrigerant for heat exchange passes, such as a suction line heat exchanger (SLHX) or a refrigerant tube. The component may be an electric wire that supplies electricity to an apparatus. As another example, the component may be a component that defines a path through which air passes, such as a cold duct, a hot air duct, and an exhaust port. As another example, the component may be a path through which a fluid such as coolant, hot water, ice, and defrost water pass. The surface component may include at least one of a peripheral adiabatic body, a side panel, injected foam, a pre-prepared resin, a hinge, a latch, a basket, a drawer, a shelf, a light, a sensor, an evaporator, a front decor, a hotline, a heater, an exterior cover, or another adiabatic body.

As an example to which the vacuum adiabatic body is applied, the present disclosure may include an apparatus having the vacuum adiabatic body. Examples of the apparatus may include an appliance. Examples of the appliance may include home appliances including a refrigerator, a cooking appliance, a washing machine, a dishwasher, and an air conditioner, etc. As an example in which the vacuum adiabatic body is applied to the apparatus, the vacuum adiabatic body may constitute at least a portion of a body and a door of the apparatus. As an example of the door, the vacuum adiabatic body may constitute at least a portion of a general door and a door-in-door (DID) that is in direct contact with the body. Here, the door-in-door may mean a small door placed inside the general door. As another example to which the vacuum adiabatic body is applied, the present disclosure may include a wall having the vacuum adiabatic body. Examples of the wall may include a wall of a building, which includes a window.

Hereinafter, the present disclosure will be described in detail with reference to the accompanying drawings. Each of the drawings accompanying the embodiment may be different from, exaggerated, or simply indicated from an actual article, and detailed components may be indicated with simplified features. The embodiment should not be interpreted as being limited only to the size, structure, and shape presented in the drawings. In the embodiments accompanying each of the drawings, unless the descriptions conflict with each other, some configurations in the drawings of one embodiment may be applied to some configurations of the drawings in another embodiment, and some structures in one embodiment may be applied to some structures in another embodiment. In the description of the drawings for the embodiment, the same reference numerals may be assigned to different drawings as reference numerals of specific components constituting the embodiment. Components having the same reference number may perform the same function. For example, the first plate constituting the vacuum adiabatic body has a portion corresponding to the first space throughout all embodiments and is indicated by reference number 10. The first plate may have the same number for all embodiments and may have a portion corresponding to the first space, but the shape of the first plate may be different in each embodiment. Not only the first plate, but also the side plate, the second plate, and another adiabatic body may be understood as well.

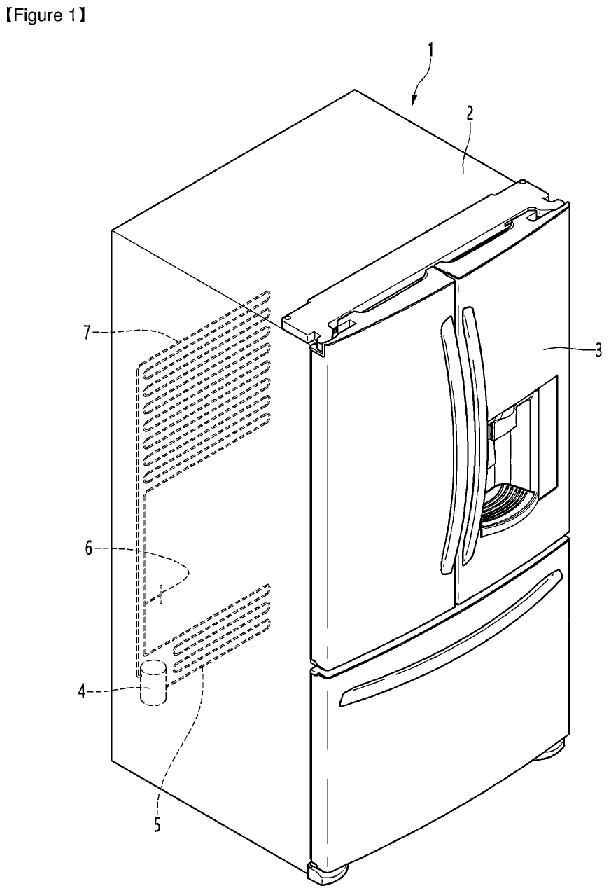

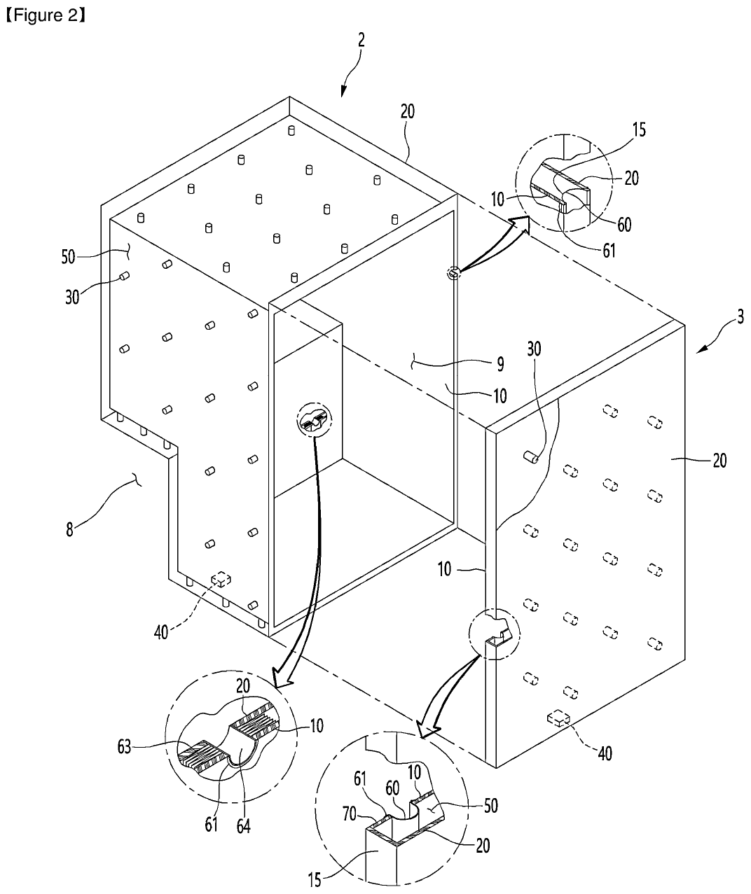

FIG. 1 is a perspective view of a refrigerator according to an embodiment, and FIG. 2 is a schematic view illustrating a vacuum adiabatic body used for a body and a door of the refrigerator. Referring to FIG. 1, the refrigerator 1 includes a main body 2 provided with a cavity 9 capable of storing storage goods and a door 3 provided to open and close the main body 2. The door 3 may be rotatably or slidably disposed to open or close the cavity 9. The cavity 9 may provide at least one of a refrigerating compartment and a freezing compartment. A cold source that supplies cold to the cavity may be provided. For example, the cold source may be an evaporator 7 that evaporates the refrigerant to take heat. The evaporator 7 may be connected to a compressor 4 that compresses the refrigerant evaporated to the cold source. The evaporator 7 may be connected to a condenser 5 that condenses the compressed refrigerant to the cold source. The evaporator 7 may be connected to an expander 6 that expands the refrigerant condensed in the cold source. A fan corresponding to the evaporator and the condenser may be provided to promote heat exchange. As another example, the cold source may be a heat absorption surface of a thermoelectric element. A heat absorption sink may be connected to the heat absorption surface of the thermoelectric element. A heat sink may be connected to a heat radiation surface of the thermoelectric element. A fan corresponding to the heat absorption surface and the heat generation surface may be provided to promote heat exchange.

Referring to FIG. 2, plates 10, 15, and 20 may be walls defining the vacuum space. The plates may be walls that partition the vacuum space from an external space of the vacuum space. An example of the plates is as follows. The present disclosure may be any one of the following examples or a combination of two or more examples.

The plate may be provided as one portion or may be provided to include at least two components connected to each other. The plate may include a first plate 10 and/or a second plate 20. One surface of the first plate (e.g., the inner surface of the first plate) may provide a wall defining the vacuum space, and the other surface (e.g., the outer surface of the first plate) of the first plate may provide a wall defining the first space. The first space may be a space provided in the vicinity of the first plate, a space defined by the apparatus, or an internal space of the apparatus. The second space may be a space provided in vicinity of the second plate, another space defined by the apparatus, or an external space of the apparatus. The side plate may include a portion extending in a height direction of a space defined between the first plate and the second plate or a portion extending in a height direction of the vacuum space. The external space of the vacuum space may be at least one of the first space or the second space or a space in which another adiabatic body to be described later is disposed. The plate may optionally include a curved portion. In the present disclosure, the plate including a curved portion may be referred to as a bent plate.

In the present disclosure, the vacuum space 50 may be defined as a third space. The vacuum space may be a space in which a vacuum pressure is maintained. In the present disclosure, the expression that a vacuum degree of A is higher than that of B means that a vacuum pressure of A is lower than that of B.

In the present disclosure, the seal 61 may be a portion provided between the first plate and the second plate. Examples of sealing are as follows. The present disclosure may be any one of the following examples or a combination of two or more examples. The sealing may include fusion welding for coupling the plurality of objects by melting at least a portion of the plurality of objects. For example, the first plate and the second plate may be welded by laser welding in a state in which a melting bond such as a filler metal is not interposed therebetween, a portion of the first and second plates and a portion of the component coupling portion may be welded by high-frequency brazing or the like, or a plurality of objects may be welded by a melting bond that generates heat. The sealing may include pressure welding for coupling the plurality of objects by a mechanical pressure applied to at least a portion of the plurality of objects. For example, as a component connected to the component coupling portion, an object made of a material having a degree of deformation resistance less than that of the plate may be pressure-coupling or pressure-welding by a method such as pinch-off or etc.

A machine room 8 may be optionally provided outside the vacuum adiabatic body. The machine room may be defined as a space in which components connected to the cold source are accommodated. Optionally, the vacuum adiabatic body may include a port 40. The port may be provided at at least any one side of the vacuum adiabatic body to discharge air of the vacuum space 50. Optionally, the vacuum adiabatic body may include a conduit 64 passing through the vacuum space 50 to install components connected to the first space and the second space.

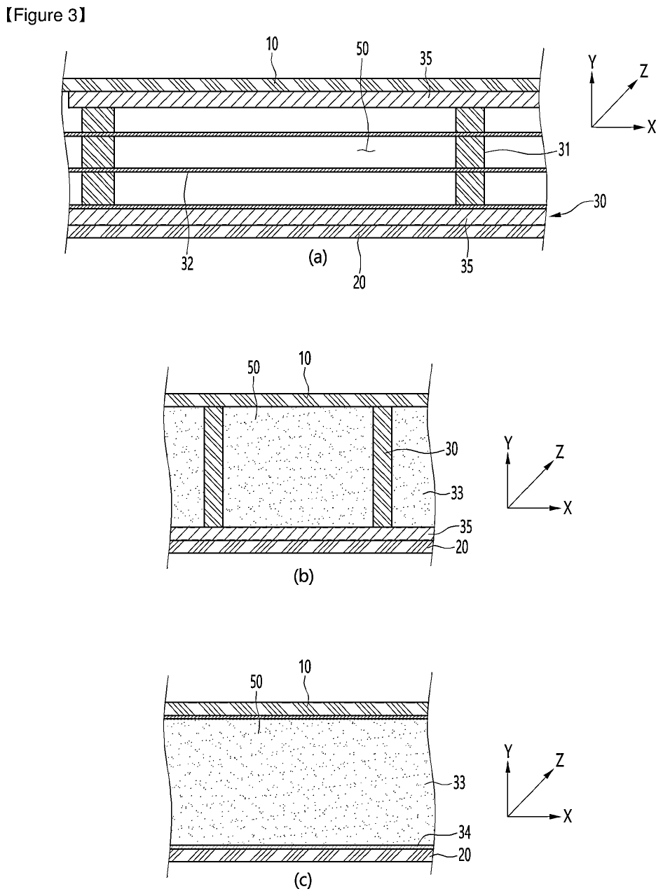

FIG. 3 is a view illustrating an example of a support that maintains the vacuum space. An example of the support is as follows. The present disclosure may be any one of the following examples or a combination of two or more examples.

The supports 30, 31, 33, and 35 may be provided to support at least a portion of the plate and a heat transfer resistor to be described later, thereby reducing deformation of at least some of the vacuum space 50, the plate, and the heat transfer resistor to be described later due to external force. Examples of the support may be the bars 30 and 31, the connection plate 35, the support plate 35, a porous material 33, and/or a filler 33. In this embodiment, the support may include at least any one of the above examples, or an example in which at least two examples are combined. As first example, the support may include bars 30 and 31.

Referring to FIG. 3a, as an embodiment, the support may include a bar 31 and a connection plate and support plate 35. The connection plate and the supporting plate may be designed separately. Referring to FIG. 3b, as an embodiment, the support may include a bar 31, a connection plate and support plate 35, and a porous material 33 filled in the vacuum space. The porous material 33 may have emissivity greater than that of stainless steel, which is a material of the plate, but since the vacuum space is filled, resistance efficiency of radiant heat transfer is high. The porous material may also function as a heat transfer resistor to be described later. More preferably, the porous material may perform a function of a radiation resistance sheet to be described later. Referring to FIG. 3c, as an embodiment, the support may include a porous material 33 or a filler 33. The porous material 33 and the filler may be provided in a compressed state to maintain a gap between the vacuum space. The film 34 may be provided in a state in which a hole is punched as, for example, a PE material. The porous material 33 or the filler may perform both a function of the heat transfer resistor and a function of the support, which will be described later. More preferably, the porous material may perform both a function of the radiation resistance sheet and a function of the support to be described later.

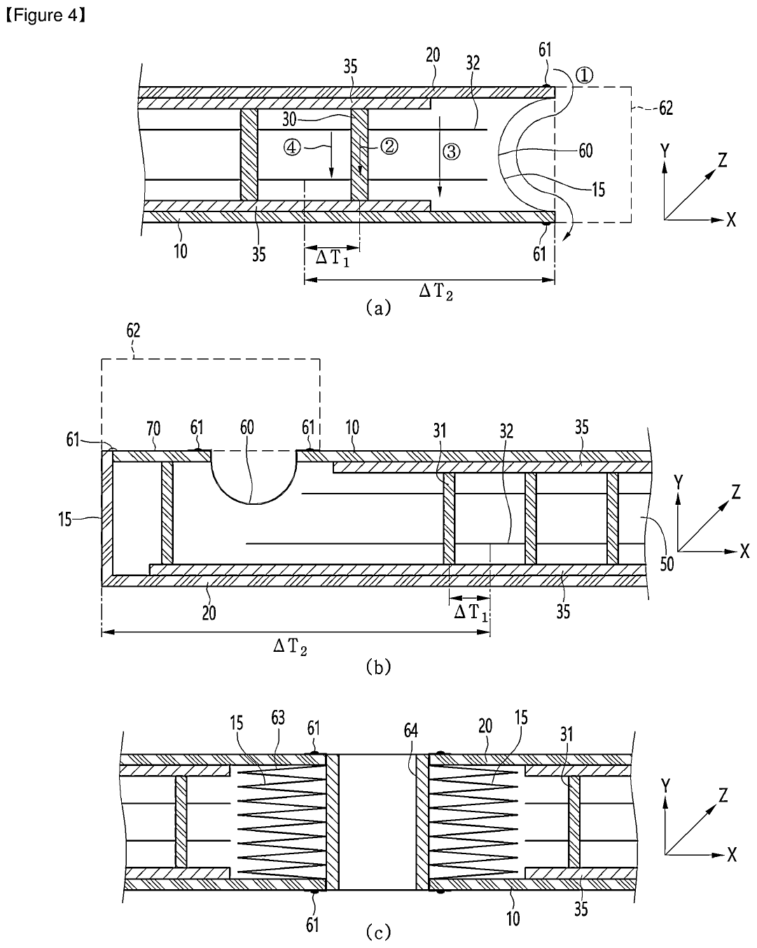

FIG. 4 is a view for explaining an example of the vacuum adiabatic body based on heat transfer resistors 32, 33, 60, and 63 (e.g., thermal insulator and a heat transfer resistance body). The vacuum adiabatic body according to the present disclosure may optionally include a heat transfer resistor. An example of the heat transfer resistor is as follows. The present disclosure may be at least any one of the following examples or a combination of two or more examples.

Referring to FIG. 4a, for example, a conductive resistance sheet may be provided on a side plate connecting the first plate to the second plate. Referring to FIG. 4b, for example, a conductive resistance sheet 60 may be provided on at least a portion of the first plate and the second plate. A connection frame 70 may be further provided outside the conductive resistance sheet. The connection frame may be a portion from which the first plate or the second plate extends or a portion from which the side plate extends. Optionally, the connection frame 70 may include a portion to which a component for sealing the door and the body and a component disposed outside the vacuum space such as the exhaust port and the getter port, which are required for the exhaust process and for maintaining the vacuum pressure respectively, are connected. Referring to FIG. 4c, for example, a conductive resistance sheet may be provided on a side plate connecting the first plate to the second plate. The conductive resistance sheet may be installed in a through-hole passing through the vacuum space. The conduit 64 may be provided separately outside the conductive resistance sheet. The conductive resistance sheet may be provided in a pleated and/or corrugated shape. Through this, the heat transfer path may be lengthened, and deformation due to a pressure difference may be prevented. A separate shielding member for insulating the conductive resistance sheet 63 may also be provided. The conductive resistance sheet may include a portion having a degree of deformation resistance less than that of at least one of the plate, the radiation resistance sheet, and/or the support. The radiation resistance sheet may include a portion having a degree of deformation resistance less than that of at least one of the plate and the support. The plate may include a portion having a degree of deformation resistance less than that of the support. The conductive resistance sheet may include a portion having conductive heat transfer resistance greater than that of at least one of the plate, the radiation resistance sheet, and/or the support. The radiation resistance sheet may include a portion having radiation heat transfer resistance greater than that of at least one of the plate, the conductive resistance sheet, and/or the support. The support may include a portion having heat transfer resistance greater than that of the plate. For example, at least one of the plate, the conductive resistance sheet, and/or the connection frame may include stainless steel material. The radiation resistance sheet may include aluminum. The support may include a resin material.

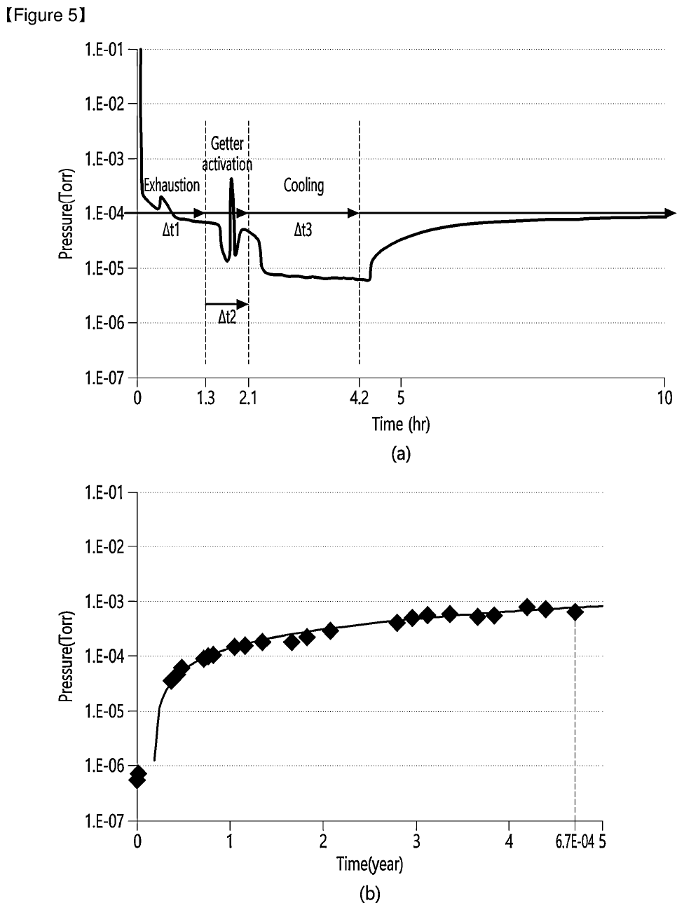

FIG. 5 is a graph for observing a process of exhausting the inside of the vacuum adiabatic body with a time and pressure when the support is used. An example of a vacuum adiabatic body vacuum exhaust process vacuum is as follows. The present disclosure may be at least any one of the following examples or a combination of two or more examples.

FIG. 5a is a graph of an elapsing time and pressure in the exhaust process according to an example, and FIG. 5b is a view explaining results of a vacuum maintenance test in the acceleration experiment of the vacuum adiabatic body of the refrigerator having an internal volume of about 128 liters. Referring to FIG. 5b, it is seen that the vacuum pressure gradually increases according to the aging. For example, it is confirmed that the vacuum pressure is about 6.7E-04 Torr after about 4.7 years, about 1.7E-03 Torr after about 10 years, and about 1.0E-02 Torr after about 59 years. According to these experimental results, it is confirmed that the vacuum adiabatic body according to the embodiment is sufficiently industrially applicable.

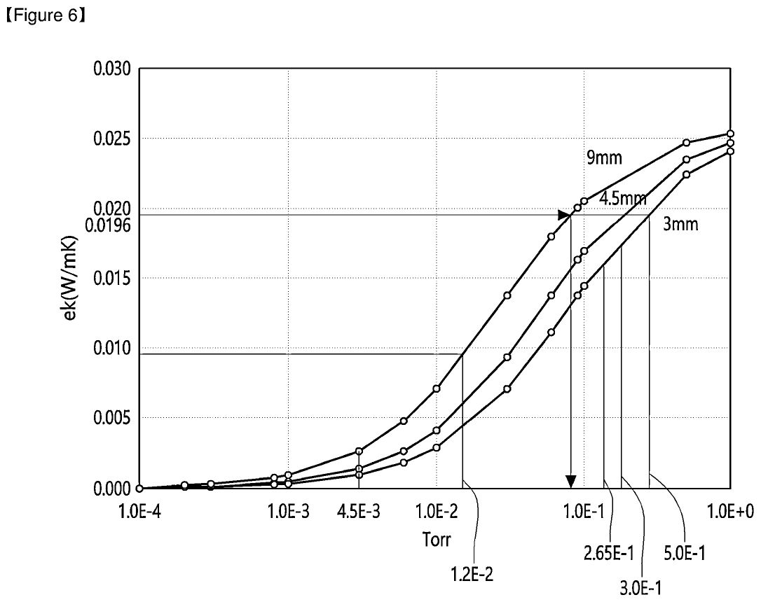

FIG. 6 is a graph illustrating results obtained by comparing the vacuum pressure with gas conductivity. Referring to FIG. 6, gas conductivity with respect to the vacuum pressure depending on a size of the gap in the vacuum space 50 was represented as a graph of effective heat transfer coefficient (eK). The effective heat transfer coefficient (eK) was measured when the gap in the vacuum space 50 has three values of about 3 mm, about 4.5 mm, and about 9 mm. The gap in the vacuum space 50 is defined as follows. When the radiation resistance sheet 32 exists inside the vacuum space 50, the gap may be a distance between the radiation resistance sheet 32 and the plate adjacent thereto. When the radiation resistance sheet 32 does not exist inside the vacuum space 50, the gap may be a distance between the first and second plates.

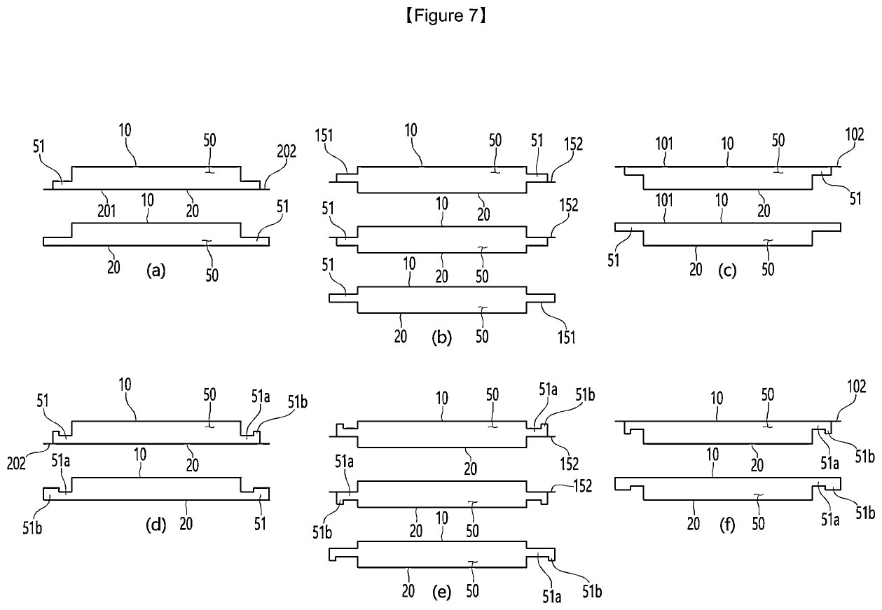

FIG. 7 is a view illustrating various examples of the vacuum space. The present disclosure may be any one of the following examples or a combination of two or more examples.

Referring to FIG. 7, the vacuum adiabatic body according to the present disclosure may include a vacuum space. Referring to FIG. 7a, the second plate may extend to provide the vacuum space expansion portion 51. The second plate may include a second portion 202 extending from a first portion 201 defining the vacuum space 50 and the vacuum space expansion portion 51. The second portion 202 of the second plate may branch a heat conduction path along the second plate to increase in heat transfer resistance. Referring to FIG. 7b, the side plate may extend to provide the vacuum space expansion portion. The side plate may include a second portion 152 extending from a first portion 151 defining the vacuum space 50 and the vacuum space extension portion 51. The second portion of the side plate may branch the heat conduction path along the side plate to improve the adiabatic performance. The first and second portions 151 and 152 of the side plate may branch the heat conduction path to increase in heat transfer resistance. Referring to FIG. 7c, the first plate may extend to provide the vacuum space expansion portion. The first plate may include a second portion 102 extending from the first portion 101 defining the vacuum space 50 and the vacuum space expansion portion 51. The second portion of the first plate may branch the heat conduction path along the second plate to increase in heat transfer resistance. Referring to FIG. 7d, the vacuum space expansion portion 51 may include an X-direction expansion portion 51a and a Y-direction expansion portion 51b of the vacuum space. The vacuum space expansion portion 51 may extend in a plurality of directions of the vacuum space 50. Thus, the adiabatic performance may be reinforced in multiple directions and may increase by lengthening the heat conduction path in the plurality of directions to improve the heat transfer resistance. The vacuum space expansion portion extending in the plurality of directions may further improve the adiabatic performance by branching the heat conduction path. Referring to FIG. 7e, the side plate may provide the vacuum space extension portion extending in the plurality of directions. The vacuum space expansion portion may reinforce the adiabatic performance of the side portion of the vacuum adiabatic body. Referring to FIG. 7f, the first plate may provide the vacuum space extension portion extending in the plurality of directions. The vacuum space expansion portion may reinforce the adiabatic performance of the side portion of the vacuum adiabatic body.

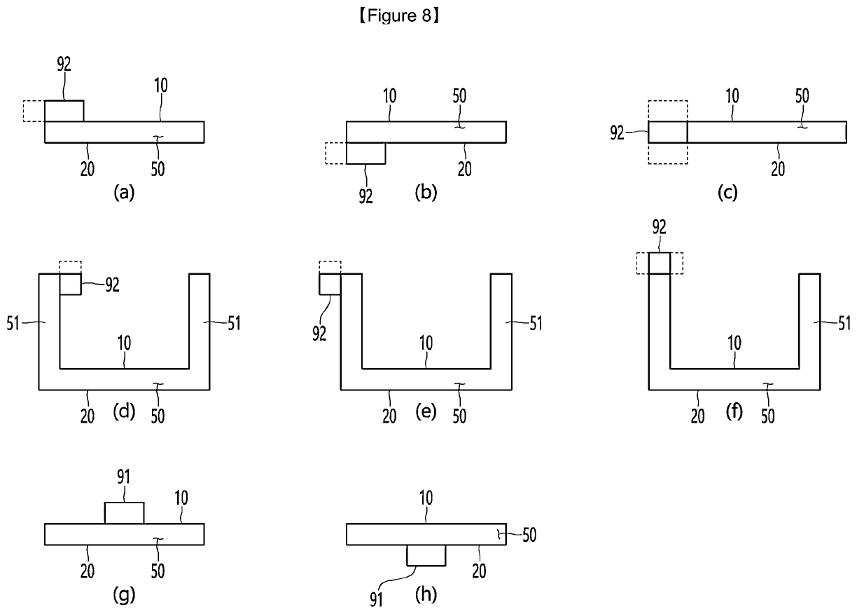

FIG. 8 is a view for explaining another adiabatic body. Referring to FIGS. 8a to 8f, another adiabatic body may include a peripheral adiabatic body. The peripheral adiabatic body may be disposed on at least a portion of a peripheral portion of the vacuum adiabatic body, a peripheral portion of the first plate, a peripheral portion of the second plate, and the side plate. The peripheral adiabatic body disposed on the peripheral portion of the first plate or the peripheral portion of the second plate may extend to a portion at which the side plate is disposed or may extend to the outside of the side plate. The peripheral adiabatic body disposed on the side plate may extend to a portion at which the first plate or may extend to the outside of the first plate or the second plate. Referring to FIGS. 8g to 8h, another adiabatic body may include a central adiabatic body. The central adiabatic body may be disposed on at least a portion of a central portion of the vacuum adiabatic body, a central portion of the first plate, or a central portion of the second plate.

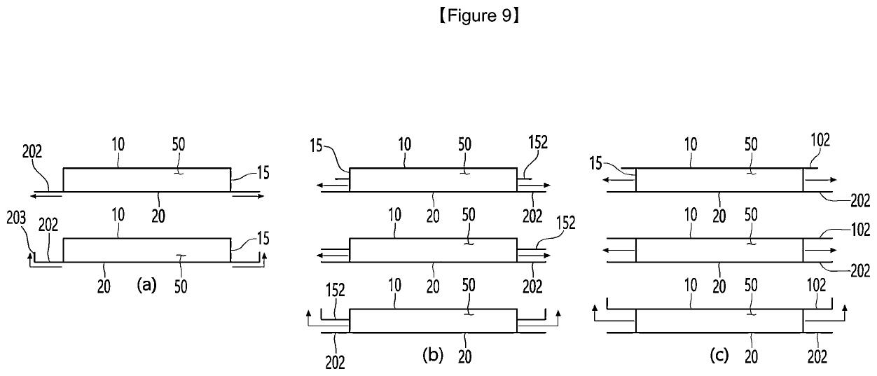

FIG. 9 is a view for explaining a heat transfer path between first and second plates having different temperatures. Referring to FIG. 9a, the second plate may include the extension portion extending to the peripheral portion of the second plate. Here, the extension portion may further include a portion extending backward. Referring to FIG. 9b, the side plate may include the extension portion extending to a peripheral portion of the side plate. Here, the extension portion may be provided to have a length that is less than or equal to that of the extension portion of the second plate. Here, the extension portion may further include a portion extending backward. Referring to FIG. 9c, the first plate may include the extension portion extending to the peripheral portion of the first plate. Here, the extension portion may extend to a length that is less than or equal to that of the extension portion of the second plate. Here, the extension portion may further include a portion extending backward.

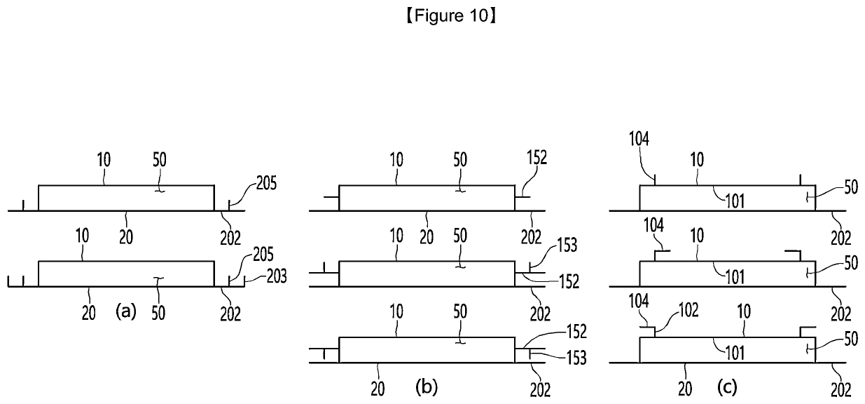

FIG. 10 is a view for explaining a branch portion on the heat transfer path between first and second plates having different temperatures. Referring to FIG. 10a, the second plate may include the branched portion 205. The branched portion may be provided in plurality, which are spaced apart from each other. The branched portion may include a third portion 203 of the second plate. Referring to FIG. 10b, the side plate may include the branched portion 153. The branched portion 153 may be branched from the second portion 152 of the side plate. The branched portion 153 may provide at least two. At least two branched portions 153 spaced apart from each other may be provided on the second portion 152 of the side plate. Referring to FIG. 10c, the first plate may include the branched portion 104. The branched portion may further extend from the second portion 102 of the first plate. The branched portion may extend toward the peripheral portion. The branched portion 104 may be bent to further extend. A direction in which the branched portion extends in FIGS. 10a, 10b, and 10c may be the same as at least one of the extension directions of the extension portion described in FIG. 10.

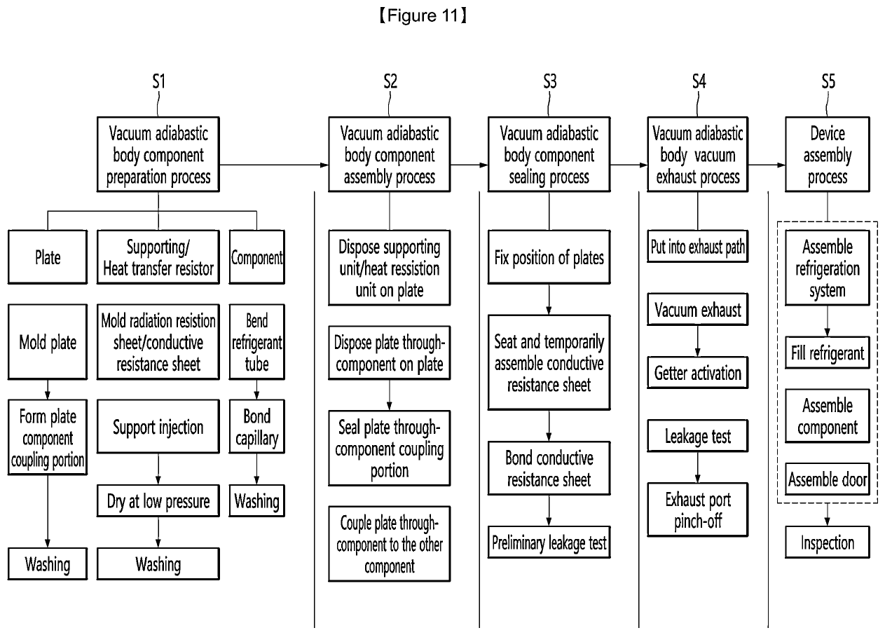

FIG. 11 is a view for explaining a process of manufacturing the vacuum adiabatic body.

Optionally, the vacuum adiabatic body may be manufactured by a vacuum adiabatic body component preparation process in which the first plate and the second plate are prepared in advance. Optionally, the vacuum adiabatic body may be manufactured by a vacuum adiabatic body component assembly process in which the first plate and the second plate are assembled. Optionally, the vacuum adiabatic body may be manufactured by a vacuum adiabatic body vacuum exhaust process in which a gas in the space defined between the first plate and the second plate is discharged. Optionally, after the vacuum adiabatic body component preparation process is performed, the vacuum adiabatic body component assembly process or the vacuum adiabatic body exhaust process may be performed. Optionally, after the vacuum adiabatic body component assembly process is performed, the vacuum adiabatic body vacuum exhaust process may be performed. Optionally, the vacuum adiabatic body may be manufactured by the vacuum adiabatic body component sealing process (S3) in which the space between the first plate and the second plate is sealed. The vacuum adiabatic body component sealing process may be performed before the vacuum adiabatic body vacuum exhaust process (S4). The vacuum adiabatic body may be manufactured as an object with a specific purpose by an apparatus assembly process (S5) in which the vacuum adiabatic body is combined with the components constituting the apparatus. The apparatus assembly process may be performed after the vacuum adiabatic body vacuum exhaust process. Here, the components constituting the apparatus means components constituting the apparatus together with the vacuum adiabatic body.

The vacuum adiabatic body component preparation process (S1) is a process in which components constituting the vacuum adiabatic body are prepared or manufactured. An example of a vacuum adiabatic body vacuum exhaust process vacuum is as follows. The present disclosure may be any one of the, examples or a combination of two or more examples. The vacuum adiabatic body vacuum exhaust process may include at least one of a process of inputting the vacuum adiabatic body into an exhaust passage, a getter activation process, a process of checking vacuum leakage and a process of closing the exhaust port. The process of forming the coupling part may be performed in at least one of the vacuum adiabatic body component preparation process, the vacuum adiabatic body component assembly process, or the apparatus assembly process. Before the vacuum adiabatic body exhaust process is performed, a process of washing the components constituting the vacuum adiabatic body may be performed. Optionally, the washing process may include a process of applying ultrasonic waves to the components constituting the vacuum adiabatic body or a process of providing ethanol or a material containing ethanol to surfaces of the components constituting the vacuum adiabatic body. The ultrasonic wave may have an intensity between about 10 kHz and about 50 kHz. A content of ethanol in the material may be about 50% or more. For example, the content of ethanol in the material may range of about 50% to about 90%. As another example, the content of ethanol in the material may range of about 60% to about 80%. As another example, the content of ethanol in the material may be range of about 65% to about 75%. Optionally, after the washing process is performed, a process of drying the components constituting the vacuum adiabatic body may be performed. Optionally, after the washing process is performed, a process of heating the components constituting the vacuum adiabatic body may be performed.

The contents described in FIGS. 1 to 11 may be applied to all or selectively applied to the embodiments described with reference to the drawings below.

As an embodiment, an example of a process associated with a plate is as follows. Any one or two or more examples among following examples of the present disclosure will be described. The process associated with the plate may selectively include a process of washing the plate. An example of a process sequence associated with the process of washing the plate is as follows. The present disclosure may be any one of the following examples or a combination of two or more examples. Before the vacuum adiabatic body vacuum exhaust process is performed, the process of washing the plate may be performed. After the process of manufacturing the plate is performed, at least one of the process of molding the plate and the process of washing the plate may be performed. After the process of molding the plate is performed, the process of washing the plate may be performed. Before the process of molding the plate is performed, the process of washing the plate may be performed. After the process of manufacturing the plate is performed, at least one of a process of providing a component coupling portion to a portion of the plate or the process of washing the plate may be performed. After the process of providing the component coupling portion to a portion of the plate is performed, the process of washing the plate may be performed.

The process associated with the plate selectively include the process of providing the component coupling portion to the plate. An example of a process sequence associated with the process of providing the component coupling portion to the plate is as follows. The present disclosure may be any one of the following examples or a combination of two or more examples. Before the vacuum adiabatic body vacuum exhaust process is performed, a process of providing the component coupling portion to a portion of the plate may be performed. For example, the process of providing the component coupling portion may include a process of manufacturing a tube provided to the component coupling portion. The tube may be connected to a portion of the plate. The tube may be disposed in an empty space provided in the plate or in an empty space provided between the plates. As another example, the process of providing the component coupling portion may include a process of providing a through-hole in a portion of the plate. For another example, the process of providing the component coupling portion may include a process of providing a curved portion to at least one of the plate or the tube.

The process associated with the plate may optionally include a process for sealing the vacuum adiabatic body component associated with the plate. An example of a process sequence associated with the process of sealing the vacuum adiabatic body component associated with the plate is as follows. The present disclosure may be any one of the following examples or a combination of two or more examples. After the process of providing the through-hole in the portion of the plate is performed, at least one of a process of providing a curved portion to at least a portion of the plate or the tube or a process of providing a seal between the plate and the tube may be performed. After the process of providing the curved portion to at least a portion of at least one of the plate or the tube is performed, the process of sealing the gap between the plate and the tube may be performed. The process of providing the through-hole in the portion of the plate and the process of providing the curved portion in at least a portion of the plate and the tube may be performed at the same time. The process of providing a through-hole in a part of the plate and the process of providing the seal between the plate and the tube may be performed at the same time. After the process of providing the curved portion to the tube is performed, the process of providing a through-hole in the portion of the plate may be performed. Before the vacuum adiabatic body vacuum exhaust process is performed, a portion of the tube may be provided and/or sealed to the plate, and after the vacuum adiabatic body vacuum exhaust process is performed, the other portion of the tube may be sealed.

When at least a portion of the plate is used to be integrated with a heat transfer resistor, the example of the process associated with the plate may also be applied to the example of the process of the heat transfer resistor.

Optionally, the vacuum adiabatic body may include a side plate connecting the first plate to the second plate. Examples of the side plate are as follows. The present disclosure may be any one of the following examples or a combination of two or more examples. The side plate may be provided to be integrated with at least one of the first or second plate. The side plate may be provided to be integrated with any one of the first and second plates. The side plate may be provided as any one of the first and second plates. The side plate may be provided as a portion of any one of the first and second plates. The side plate may be provided as a component separated from the other of the first and second plates. In this case, optionally, the side plate may be provided to be coupled or sealed to the other one of the first and second plates. The side plate may include a portion having a degree of strain resistance, which is greater than that of at least a portion of the other one of the first and second plates. The side plate may include a portion having a thickness greater than that of at least a portion of the other one of the first and second plates. The side plate may include a portion having a curvature radius less than that of at least a portion of the other one of the first and second plates.

The contents described in FIGS. 1 to 11 may be applied to all or selectively applied to the embodiments described with reference to the drawings below.

The installation of the tube will be schematically described.

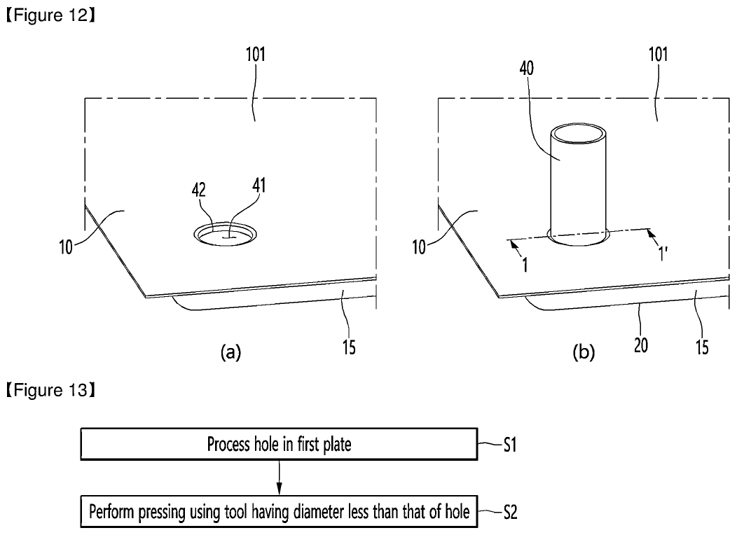

FIG. 12 is a perspective view in which a tube is installed in a vacuum adiabatic body. Here, (a) of FIG. 12 is a view illustrating a state before the tube is coupled, and (b) of FIG. 12 is a view illustrating a state after the tube is coupled.

Referring to FIG. 12, the vacuum adiabatic body according to one or more embodiments may have a tube 40. The tube 40 may be a tube for exhausting a fluid of the vacuum space 50. The tube 40 may be a tube for a getter, in which a getter for gas ad-sorption is supported. The tube 40 may serve as an exhaust port and a getter port.

Optionally, a thickness of the tube may be greater than that of the first plate 10. The thickness of the tube may be provided to be thicker than that of the second plate 20. The thickness of the tube may be provided to a thickness that is sufficient to withstand compression required for sealing the tube. The sealing may be performed through pinch-off. The tube may have a sufficient wall thickness.

Optionally, the tube may be provided as a circular or oval hollow tube made of a metal. The tube may be sealed after the exhaust or after inserting the getter. The tube may be sealed through pressure welding. The tube may be sealed by deforming the tube. The tube may be sealed through pinching-off. The tube may be made of copper (CU) for easy deformation. Copper having strength less than that of stainless steel may be used as the tube. Since the easily deformable copper is used, the pinch-off process may be smoothly performed. In addition, it is possible to reliably provide the seal. Optionally, the flange 42 may have a predetermined height portion HL extending in a height direction of the vacuum space. The curvature portion may guide the tube 40. The curvature portion may allow the tube to be conveniently inserted into the through-hole 41. Examples of the aforementioned tube may be ports such as an exhaust port or a getter port.

FIG. 13 is a view for explaining a method of processing the through-hole of the first plate.

Referring to FIG. 13, a hole may be processed in the first plate 10 (S1). Thereafter, the hole may be pressed using a pressing tool having a diameter greater than that of the hole (S2).

Optionally, to smoothly form the flange 42 in the burring process, the following method may be applied. It may provide small force compared to the force applied in the general burring process. The force may be applied gradually for a longer time than that required for the general burring process. A first curvature may be processed in the peripheral portion of the hole provided by the piercing process between the piercing process and the burring process. During the burring process, a support having a groove corresponding to a desired shape of the burr may be provided on a surface on which the burr is generated. It may provide the flange 42 having a small curvature radius R through the above process. A portion at which the curvature radius is formed may be referred to as a curvature portion. Examples of the aforementioned tube may be ports such as an exhaust port or a getter port.

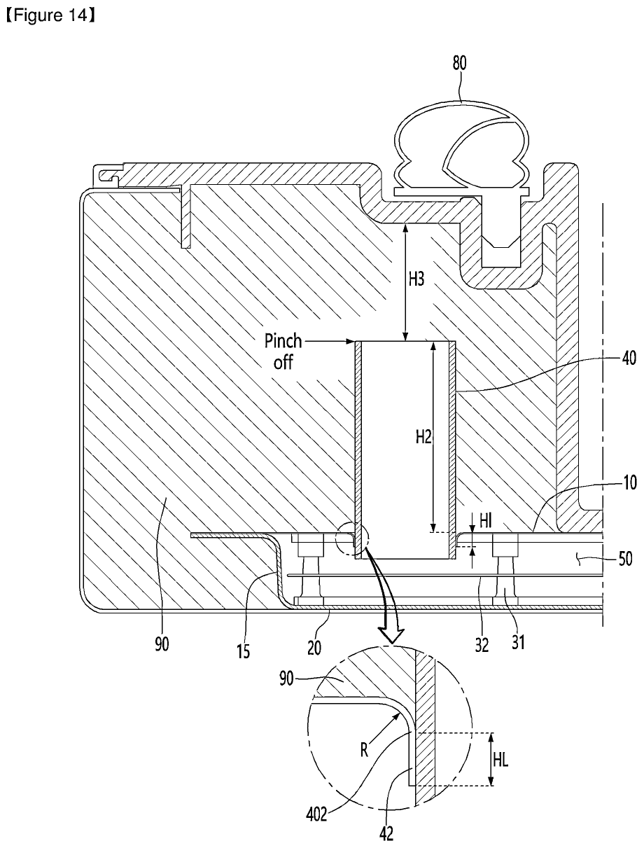

FIG. 14 is a cross-sectional view taken along line 1-1′ of FIG. 12b. For reference, FIG. 14 illustrates a state in which the vacuum adiabatic body is applied to a door. A cross-section of the tube and its related configuration will be described with reference to FIG. 14.

In one or more embodiments, the first plate 10 may have a thickness of at least about 0.1 mm or more. Thus, it may secure rigidity to obtain process stability when inserting the tube 40. The thickness of the first plate 10 may be about 0.1 mm. The second plate 20 may have a thickness of about 0.5 mm or more. The thin first plate 10 may be provided because conductive heat decreases. If the first plate 10 is thin, there may be a disadvantage that it is vulnerable to deformation. When the tube 40 is inserted into the through-hole 41, the first plate 10 in the vicinity of the through-hole 41 may be deformed. Optionally, A height H1 of the flange 42 may be provided to be about 1 mm or more and about 3 mm or less. When the height of the flange 42 exceeds about 3 mm, there is a high risk that the heat transfer resistor 32 and the flange 42 are in contact with each other. Optionally, the curvature radius R of the curvature portion of the flange 42 defining the through-hole 41 may be less than that of each of all bent portions provided on the first plate 10. The curvature radius R of the flange 42 defining the through-hole 41 may be less than that of each of all bent portions provided on the second plate 20. Optionally, the tube may be insulated with the additional adiabatic body 90. The additional adiabatic body 90 may insulate a gap between the tube 40 and the first space and/or a gap between the tube 40 and the second space. Examples of the aforementioned tube may be ports such as an exhaust port or a getter port.

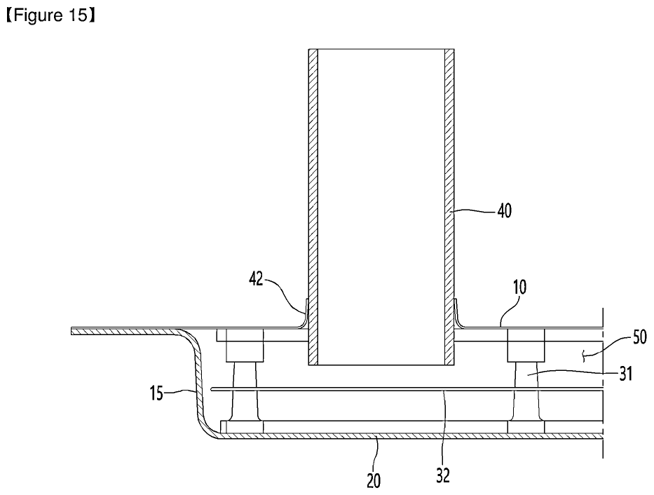

FIG. 15 illustrates an example in which a flange extends toward the outside of the vacuum space. other structure and function are same with the another one or more embodiments.

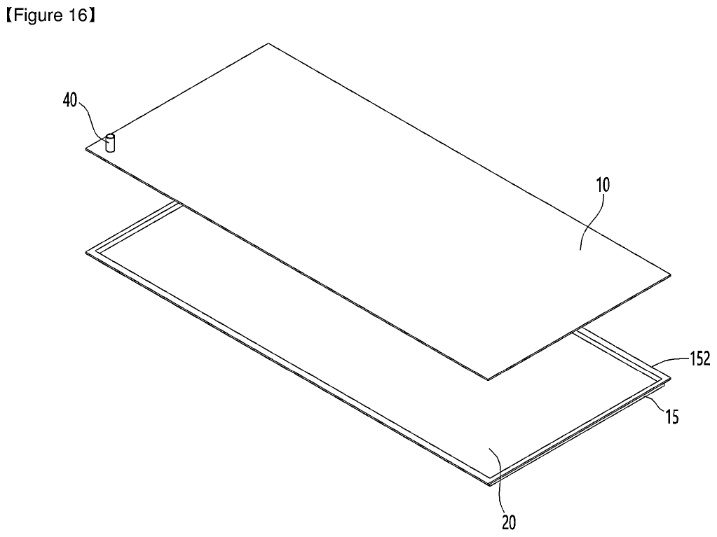

FIGS. 16 to 18 are views for explaining a method for manufacturing a vacuum adiabatic body.

Referring to FIG. 16, in one or more embodiments, the second plate 20 may be processed to form an accommodation space. The first plate 10 and the second plate 20 may be fastened to each other. The side plate 15 and the second plate 20 may be bent to each other to form the accommodation space. The side plate 15 and the second plate 20 may extend in different directions from each other.

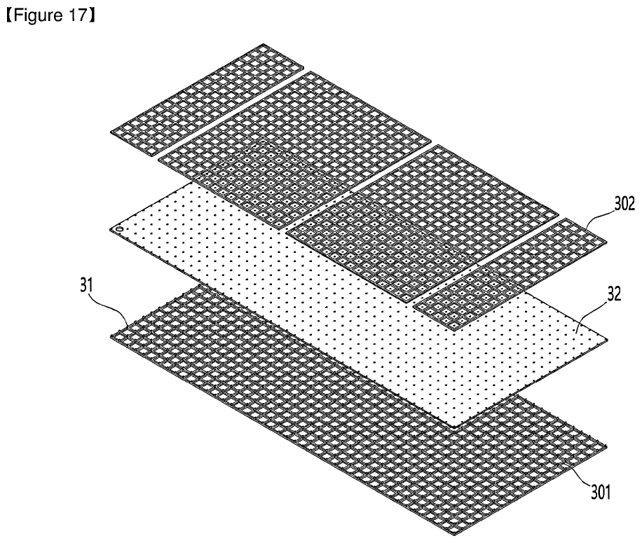

Referring to FIG. 17, in one or more embodiments, at least one of the first support 301 and the second support 302 may provide a resin as a material. Through this, the thermal conductivity can be lowered. The outer panel and the inner panel may also provide a resin as a material in order to lower the thermal conductivity.

Optionally, at least one of the first support 301 and the second support 302 may be provided as at least two spaced apart components. The figure illustrates that the second support 302 is made of components that are spaced apart from each other. Each component of the first support 301 and each component of the second support 302 may be alternately connected to each other. A component of the second support 302 may be placed between two components of the first support 301 that are spaced apart from each other.

Optionally, a heat transfer resistor 32 may be placed in the middle of the first and second supports 30. The position of the heat transfer resistor 32 may be fixed by fastening the first and second supports 301 and 302. In the vacuum adiabatic body component assembling step S2, the support 30, the heat transfer resistor, and the through-component may be assembled to the plate. Here, the heat transfer resistor may include the radiation resistance sheet 32. The heat transfer resistor may include other components.

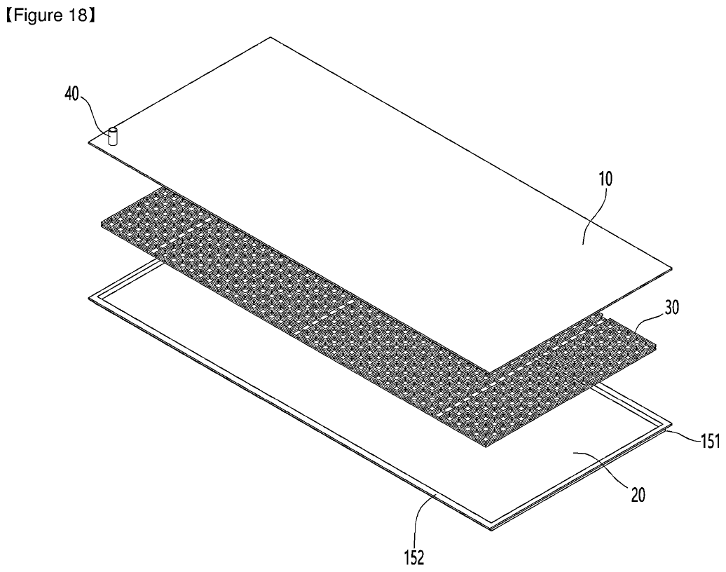

Referring to FIG. 18, optionally, after the first and second supports 301 and 302 and the heat transfer resistor are fastened, the assembly of the support 30 and the heat transfer resistor 32 may be placed in the accommodation space. After the assembly is placed in the accommodation space, the first plate 10 may be placed on the second plate 20. The second plate 20 and the first plate 10 may be sealed with each other in the second portion 152 of the side plate. For sealing, sealing may be performed.

Optionally, in the vacuum adiabatic body component sealing step S3, the vacuum space 50 may be sealed with respect to the first space and the second space. The vacuum adiabatic body component sealing step S3 may be performed by sealing the first plate 10 and the second plate 20.

Hereinafter, the strength reinforcement portion of the first plate will be described.

Optionally, if the first plate 10 is thin, side effects may occur. If the first plate is thin, the first plate may be vulnerable to deformation. When the plates are welded, temporary vacuum may be applied to bring the plate members into close contact. The temporary vacuum may be different from the vacuum process of evacuating the vacuum space 50. The first plate may be vulnerable to the deformation when the temporary vacuum is applied. The first plate may be vulnerable to the deformation at a portion where the support is discontinuous. Deformation of the first plate 10 may cause welding defects. This is because the contact of the two plates may be spaced apart from each other. The welding defect is an important problem leading to the disposal of the vacuum adiabatic body.

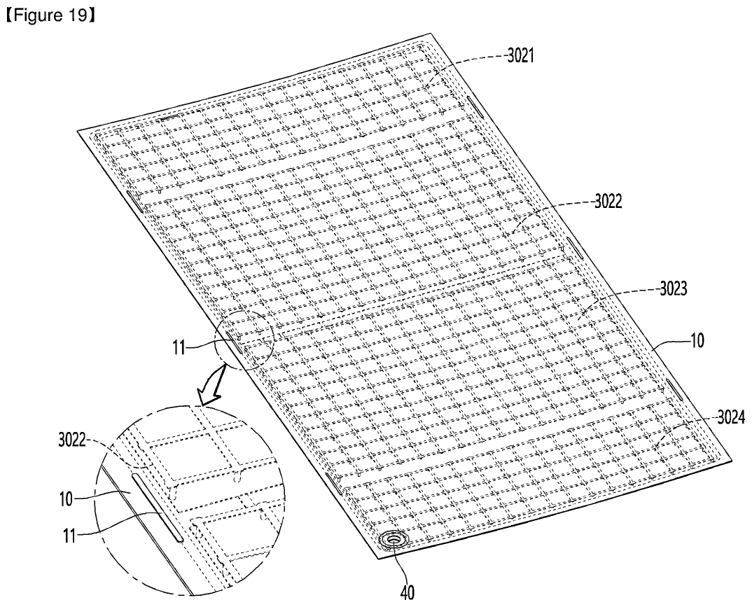

FIG. 19 is a perspective view illustrating a vacuum adiabatic body according to the embodiment.

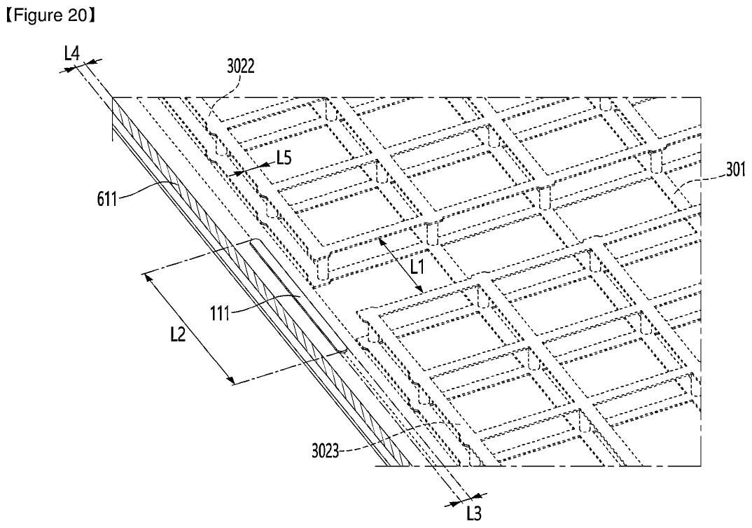

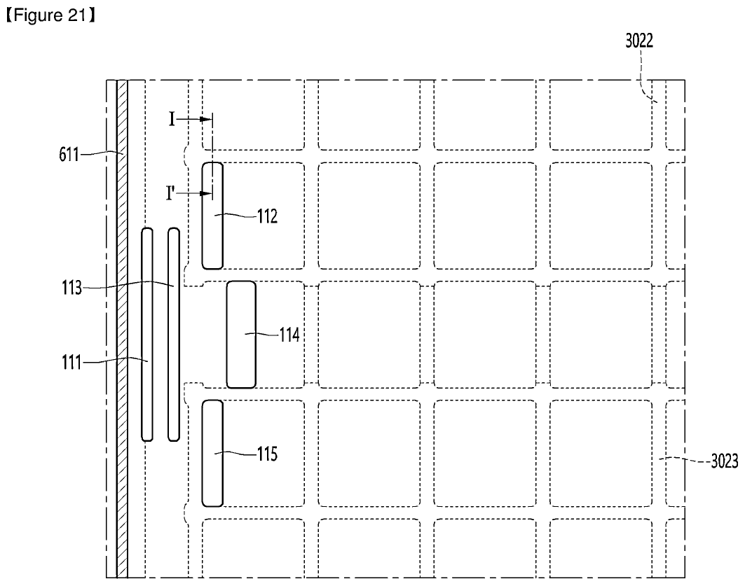

Referring to FIG. 19, in one or more embodiments, the vacuum adiabatic body may include a strength reinforcement portion 11 in the first plate 10. The strength reinforcement portion 11 may reinforce the strength of the first plate 10. The strength reinforcement portion 11 may reinforce the strength of the vacuum adiabatic body. The strength reinforcement portion 11 may prevent deformation of the first plate 10. Optionally, the first plate and the support may have areas aligned in a thickness direction of the vacuum space. The strength reinforcement portion may be provided correspondingly between the two components providing support. The strength reinforcement portion may be provided to be spaced apart from at least two places of the first plate. The strength reinforcement portion may be provided to be spaced apart from six places of the first plate. The second support 302 may be divided into at least two components. The second support 302 may include first to fourth components 3021, 3022, 3023, and 3024. Of course, the second support may have more or fewer components. The spacing between the components 3021, 3022, 3023, and 3024 may have a different characteristic from the grid inside the component. The characteristic may include at least one of a difference in length between the grid and the gap, the presence or absence of a support structure in the short side direction of the first plate, and the presence or absence of discontinuous support. Due to the above characteristics, the deformation of the first plate may make the gap between the two components more vulnerable. The distance between the two components may extend in one direction. The strength reinforcement portion 11 may be provided in the peripheral portion of the first plate corresponding to the spacing between the two components. The strength reinforcement portion 11 may suppress the propagation of the deformation of the first plate occurring in the gap between the two components. The strength reinforcement portion 11 may suppress the propagation of the deformation of the first plate to the seal (611 in FIG. 20). When viewed from the first plate, the strength reinforcement portion 11 may be placed inside the seal 611. A gap between the strength reinforcement portion 11 and the seals 611 may be 1 millimeter or more. There may be a gap between the strength reinforcement portion 11 and the seal 611. Due to the gap, the shape of the strength reinforcement portion itself may not affect the seal. The seal may be a weld. The strength reinforcement portion 11 may improve close contact performance during the sealing process of the two members to be sealed. The strength reinforcement portion 11 can improve the close contact performance of the two members to be sealed after the sealing process. The strength reinforcement portion 11 may be provided on the plate in the vacuum adiabatic body component preparation step. Optionally, the strength reinforcement portion 11 may increase the flatness of the first plate in an area corresponding to the seal 611. The seal may be an area to which at least two members are fastened. Optionally, the positioning state of the support 31 may be checked by using the strength reinforcement portion 11. Optionally, the support 31 may be positioned to be tilted toward one side from the inside of the vacuum space 50. In this case, the strength reinforcement portion may be pushed to one side. The operator can check the inclination of the support or the gap between components by using the inclination of the strength reinforcement portion. The operator can pick up the first plate and rework the support. The operator can work more accurately when the strength reinforcement portion 11 corresponds to a specific position of the support (for example, 114 in FIG. 21).

FIG. 20 is a view illustrating in detail the relationship between the strength reinforcement portion and the configuration. The strength reinforcement portion 111 according to an example will be described in detail with reference to FIG. 20.

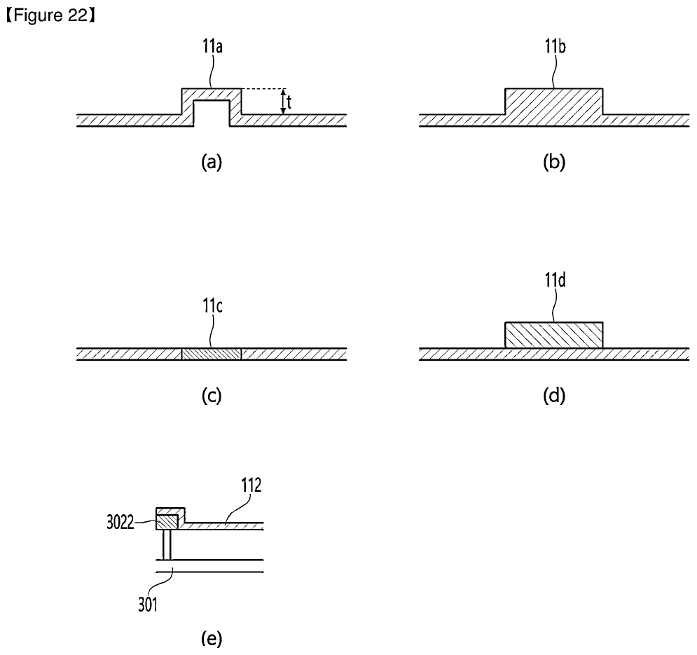

Optionally, the strength reinforcement portion 111 may protrude from the first plate. The strength reinforcement portion 111 may be placed inside the seal 611. The width L3 of the strength reinforcement portion 111 may be shorter than the length L2. The width L3 of the strength reinforcement portion 111 may be greater than the width L4 of the seal. The width L3 of the strength reinforcement portion 111 may be smaller than the width L5 of the support frame. The width L3 of the strength reinforcement portion 111 may be greater than the thickness (t in FIG. 22(a)) of the strength reinforcement portion 111. The width L3 of the strength reinforcement portion 111 may be 1-3 millimeters, preferably 2 millimeters. The thickness of the strength reinforcement portion 111 (t in FIG. 22(a)) may be thicker than the thickness of the first plate. The length L2 of the strength reinforcement portion 111 may be longer than the distance L1 between the support components.

FIG. 21 is a view illustrating an embodiment of the strength reinforcement portion according to the location. Any one of the strength reinforcement portions illustrated in FIG. 21 may not exclude the other strength reinforcement portion illustrated in FIG. 21. At least one of the strength reinforcement portions illustrated in FIG. 21 may be provided. At least one of the strength reinforcement portions illustrated in FIG. 21 may be provided on the first plate. At least one of the reinforcement portions illustrated in FIG. 21 may be placed in a gap between the two components in different positions. The description of any one of the strength reinforcement portions illustrated in FIG. 21 may be applied to the description of other strength reinforcement portions of the present specification.

Referring to FIG. 21, the description as described in FIG. 20 may be applied to the first strength reinforcement portion 111. At least one of the second to fifth strength reinforcement portions 112, 113, 114, and 115 may be provided.

Optionally, the second strength reinforcement portion 112 may be placed inside the grid area of the support. The second strength reinforcement portion 112 may be disposed to correspond to any corner of the inner area of the grid of the support. FIG. 22(e) is a cross-sectional view taken along line 1-1′ of FIG. 21. Referring to FIG. 22(e), the second strength reinforcement portion 112 may protrude downward of the first plate. Optionally, For the fifth strength reinforcement portion 115, the same description as that of the second strength reinforcement portion may be applied. The fifth strength reinforcement portion 115 may be different from the second strength reinforcement portion 112 only when fifth strength reinforcement portion is installed to correspond to the third component 3023. Optionally, the third strength reinforcement portion 113 may be provided inside the first strength reinforcement portion 111. Optionally, the fourth strength reinforcement portion 114 may be placed in an area of the first plate corresponding to the gap between the two components. At least one end of the fourth strength reinforcement portion 114 may be in contact with at least one corner of the second component 3022 and the third component 3023.

FIG. 22 is a view illustrating another embodiment of another strength reinforcement portion according to the method for providing the strength reinforcement portion. Any one of the strength reinforcement portions illustrated in FIG. 22 may not exclude the other strength reinforcement portion illustrated in FIG. 22. At least one of any one of the strength reinforcement portions illustrated in FIG. 22 may be provided. At least one of the strength reinforcement portions illustrated in FIG. 22 may be provided on the first plate. The description of any one of the strength reinforcement portions illustrated in FIG. 22 may be applied to the description of other strength reinforcement portions of the present specification.

FIG. 22(a) illustrates the formed strength reinforcement portion 11a protruding or processing in at least one direction. Optionally, the formed strength reinforcement portion 11a may be provided by a method exemplified by at least one of pressing, forming, and hitting. The formed strength reinforcement portion 11a may increase the moment of inertia of the first plate. The shape of the formed strength reinforcement portion may be exemplified by various shapes such as a straight line, a circle, an oval, a rectangle, and a polygon.

The formed strength reinforcement portion 11a may preferably be exemplified to protrude upward. The formed strength reinforcement portion 11a may facilitate the formation of the seal 611.

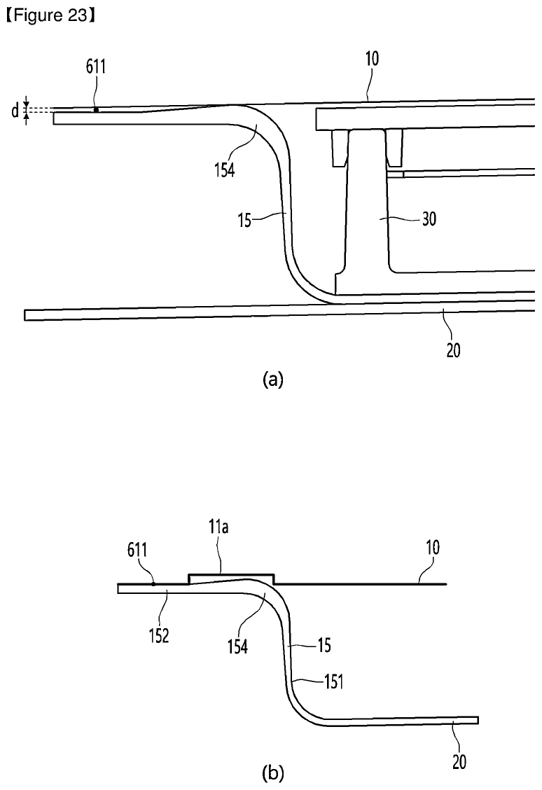

FIG. 23 is a view for explaining the action of the formed strength reinforcement portion 11a. Referring to FIG. 23, optionally, another deformation portion 154 having a different thickness may be provided in the member sealed with the first plate. The deformation portion may occur for any one of the reasons of forming the plate and reinforcing the strength of the plate. Another deformation portion 154 may be provided at a boundary between the first and second side plates 151 and 152. Another deformation portion 154 may be thicker than other portions of the second plate 20 and/or the side plate 15. Another deformation portion 154 may protrude upward. The formed strength reinforcement portion 11a formed upward may accommodate another deformation portion 154 in the formed inside. In the seal 611, the first plate and the side plate 15 may be in close contact with each other. The formed strength reinforcement portion 11a may help to position the first plate and the second plate. The formed strength reinforcement portion 11a may reduce the influence of high heat on the support during welding of the seal 611. The formed strength reinforcement portion 11a may contribute to the quality improvement of the support. The formed strength reinforcement portion 11a may move a position where the first plate contacts the side plate to the outside. The strength reinforcement portion 11a may lengthen the heat transfer path of the vacuum adiabatic body. The heat insulating effect of the vacuum adiabatic body can be improved by the lengthened heat transfer path of the strength reinforcement portion.

Optionally, the formed strength reinforcement portion 11a may not be provided in FIG. 23(a). In this case, a gap d may occur between the first plate and the side plate 15 in the seal 611. The gap d may be a major cause of welding defects. In FIG. 23(b), the formed strength reinforcement portion 11a may be provided. In this case, the first plate and the side plate 15 may be in close contact with each other in the seal 611. In the seal 611, the first plate and the second plate 20 may be in close contact with each other. When the formed strength reinforcement portion 11a protrudes downward, the gap d may be larger. The present disclosure does not exclude that the formed strength reinforcement portion protrudes downward.

It will be described again with reference to FIG. 22. FIG. 22(b) illustrates different shape strength reinforcement portion 11b protruding upward. Optionally, the different shape strength reinforcement portion 11b may increase the thickness of the first plate. The different shape strength reinforcement portion 11b may be made of the same material to increase the moment of inertia of the first plate. FIG. 22(c) illustrates a different material strength reinforcement portion 11b. The different material strength reinforcement portion 11b may increase the strength of the first plate. In the area of the different material strength reinforcement portion 11b, the rigidity of the first plate may be increased by using a high-strength material. FIG. 22(d) illustrates the additional strength reinforcement portion 11b added a predetermined member upward. The additional strength reinforcement portion 11b may add another member to increase the thickness of the first plate. The additional strength reinforcement portion 11b may increase the moment of inertia of the first plate as a whole by adding the same or different materials to the first plate.

Optionally, the formed strength reinforcement portion and the different shape strength reinforcement portion may be provided as a non-separable type or integrally formed that is not separated from the first plate. The additional strength reinforcement portion may be separated from the first plate, or may be provided as a separate or additional type in which a predetermined member is added to the first plate. Various methods such as partial alloying, substitution, or welding may be applied to the different material strength reinforcement portion. At least one of a non-separable type, an integral type, a separate type, and an additional type can be applied to the different material strength reinforcement portion.

In one or more embodiments, a tube 40 may be fastened to the first plate 10. The first plate may be deformed by at least one of the weight of the tube and a force applied to the first plate through the tube. A contact portion between the first plate and the tube may be coupled to each other. A contact portion between the first plate and the tube may be blazed. The heat applied during the brazing may warp the first plate. The warpage of the first plate may lead to deformation of the first plate. Deformation of the first plate may adversely affect the seal 611. Deformation of the first plate may damage or vacuum break the sealing part 611. Deformation of the first plate may cause the insulation loss of the vacuum adiabatic body.

Optionally, the fastening of the first plate and the tube may be performed in the vacuum adiabatic body component assembly step or component preparation step. The fastening between the first plate and the tube may be performed before the vacuum adiabatic body component sealing step. The fastening between the first plate and the tube may be performed before the vacuum adiabatic body vacuum evacuation step of evacuating the internal air of the vacuum space.

The strength reinforcement portion provided to correspond to the tube may be referred to as a tube strength reinforcement portion, compared with the support strength reinforcement portion related to the support disclosed in FIGS. 19 to 23 previously described. In any case, since it is the strength reinforcement portion of the first plate, it can be referred to as a strength reinforcement portion without distinction. The description of the strength reinforcement portion of an embodiment may be applied to any other embodiment.

In one or more embodiments, a strength reinforcement portion 11 may be provided where the tube is fastened in the first plate. The strength reinforcement portion 11 corresponds to the operation of the tube 40 and thus may also be referred to as a tube strength reinforcement portion. In the following description, the strength reinforcement portion may refer to a tube strength reinforcement portion unless otherwise specified. The description of the tube strength reinforcement portion may be applied to the support strength reinforcement portion. The tube strength reinforcement portion may suppress deformation of the first plate due to the tube. The tube strength reinforcement portion can prevent the adverse effect of the vacuum adiabatic body according to the deformation of the first plate caused by the tube.

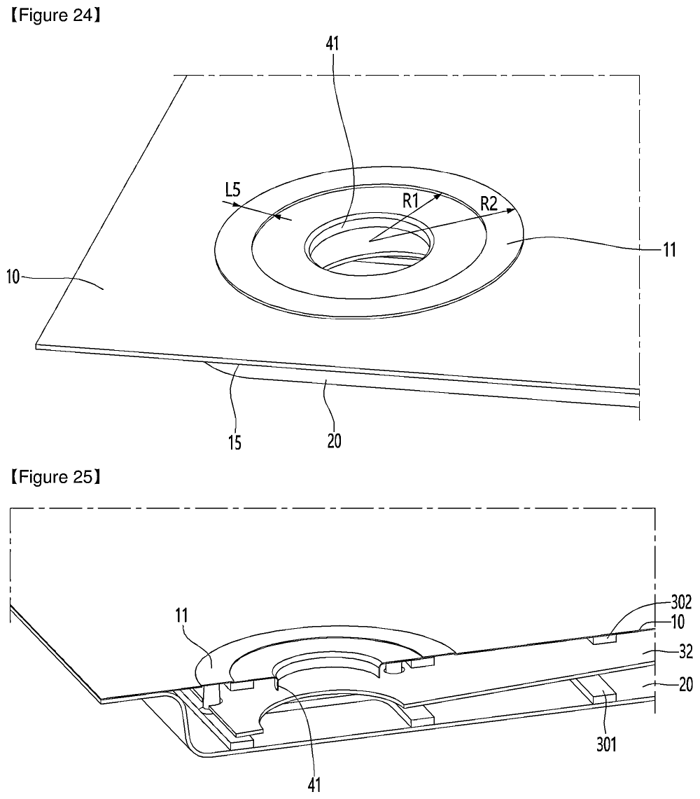

FIG. 24 is an enlarged view illustrating a portion of a first plate on which a tube is installed, and FIG. 25 is a cross-sectional perspective view illustrating a state where the vacuum adiabatic body is cut in the thickness direction of the vacuum adiabatic body centering on the strength reinforcement portion. Referring to FIGS. 24 and 25, a flange 41 may be formed on the outer periphery of the hole into which the tube 40 is inserted. A strength reinforcement portion 11 may be provided on the outside spaced apart from the flange. The strength reinforcement portion may be provided by various providing methods described above. The strength reinforcement portion may include at least one of a separate type/integral type/non-separate type/additional type. The strength reinforcement portion 11 may have an inner portion and an outer portion. The inner portion may lie on the inside of the outer portion. The distance R1 from the geometric center of the strength reinforcement portion 11 to the inner portion and the distance R2 from the geometric center of the strength reinforcement portion 11 to the outer portion may be different from each other. The geometric centers for the inner portion and the outer portion may be different, respectively. The geometric center may be a mean center. The geometric center for the inner portion and the outer portion may be the same. At least one of the inner portion and the outer portion may form a closed curve. The closed curve may include at least one of a circle, an ellipse, and a polygon. The flange 41 may be placed inside the closed curve. At least one of the inner portion and the outer portion may pass through the support. At least one of the inner portion and the outer portion may be larger than the grid of the support. At least one of the inner portion and the outer portion may be opened.

Optionally, the strength reinforcement portion 11 may protrude in a direction opposite to the flange 41. The strength reinforcement portion may protrude upward. The strength reinforcement portion may not be in contact with the support 31. The strength reinforcement portion may protrude downward. The strength reinforcement portion may be in contact with the frame of the support. The flange 41 may be placed in any one grid of the support. The grid may be rectangular. This arrangement can be used to prevent interference between the tube and the support.

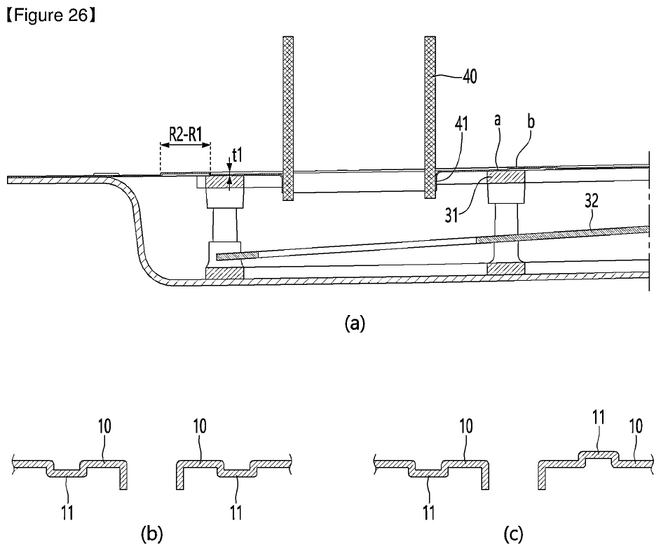

FIG. 26 is a cross-sectional view illustrating a vacuum adiabatic body for explaining a strength reinforcement portion. Referring to FIG. 26(a), the width R1-R2 of the tube strength reinforcement portion may be greater than the width L3 of the support strength reinforcement portion. The width of the strength reinforcement portion may be provided in 3-5 millimeters. The width of the strength reinforcement portion may be provided as 4 millimeters. The height of the strength reinforcement portion t1 may be 0.1-0.3 mm. The height of the strength reinforcement portion t1 may be 0.2 mm. A second area b in which the strength reinforcement portion 11 and the support 31 is not in contact with each other may be included. In the second area, the strength reinforcement portion 11 and the support 31 may be aligned. The first plate may have a first area a connected to the second area b. In the first area a, the strength reinforcement portion 11 and the support 31 may be aligned. In the first area a, the strength reinforcement portion 11 and the support 31 may be in contact with each other.

FIG. 26(b) illustrates an embodiment in which the strength reinforcement portion protrudes downward. FIG. 26(b) illustrates an embodiment in which the strength reinforcement portion protrudes partly upward and partly downward. In addition, various embodiments that can achieve the result of strength reinforcement may be included.

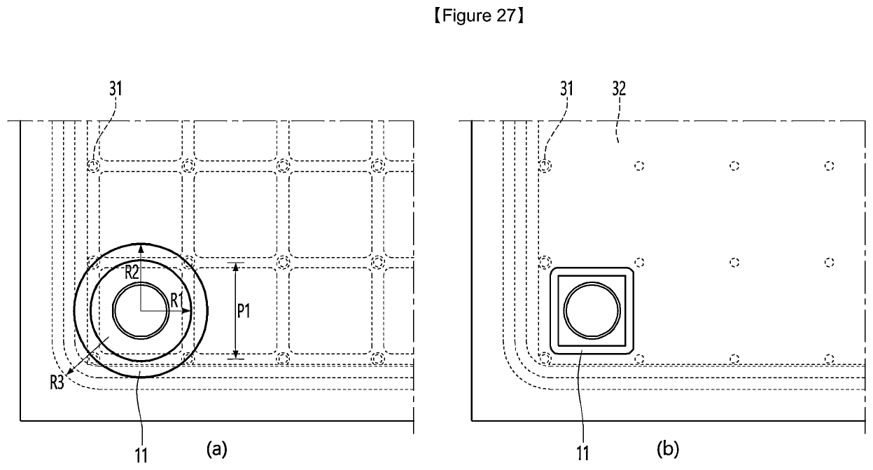

FIG. 27 is a plan view illustrating the vacuum adiabatic body, and describes the alignment relationship between the support and the strength reinforcement portion with reference to FIG. 27. Referring to FIG. 27(a), the outer portion of the strength reinforcement portion 11 may be larger than the average grid P1 of the support. The strength reinforcement portion may be provided in a shape different from that of the grid of the support. The outer portion of the strength reinforcement portion 11 may be larger than the outer grid of the support. The inner portion of the strength reinforcement portion 11 may be larger than the inner portion of the grid of the support. The inner portion of the strength reinforcement portion 11 may be larger than the outer portion of the grid of the support. The radius of curvature R3 of the corner portion of the vacuum adiabatic body may have a smaller portion than the radius of curvature R1 of the inner portion of the strength reinforcement portion. The radius of curvature R2 of the outer portion of the strength reinforcement portion may be greater than the radius of curvature R3 of the corner portion of the vacuum adiabatic body.

Referring to FIG. 27(b), at least one of the inner portion and the outer portion of the strength reinforcement portion may be provided in a rectangular shape. The strength reinforcement portion may be provided in a shape corresponding to the grid of the support. The corners of the rectangle may be rounded. At least any portion of the outer portion may be in contact with an inner surface of the grid of the support. The two opposite surfaces of the strength reinforcement portion may be in contact with the inner surface of the grid of the support. The strength reinforcement portion may assist in positioning the first plate and the support. The strength reinforcement portion may not be in contact with the heat transfer resistor 32.

The oxidation prevention process of the seal will be described. The seal may be weak compared to other portions. The seal may be a weld. If the seal is provided by welding, the seal may be susceptible to corrosion. The welding may be performed by laser welding. A filler metal may not be added to the laser welding. The seal may be subjected to high heat treatment. The seal may be oxidized during high heat treatment. The oxide film may be vulnerable to corrosion. The oxide film may have low strength. The oxide film may have a predetermined volume. Even if oxygen access is blocked during the high heat treatment, an oxide film may be formed. If oxygen access is not blocked during the high heat treatment, the oxide film may be generated in a large amount.

One or more embodiments for inhibiting the oxide film are described. Optionally, at least one of the first and second plates may include at least two of a first material, a second material, and a third material. The first material may include at least iron (Fe). The second material may include at least chromium (Cr). The second material may include nickel (Ni). The third material may include at least molybdenum (MO). The seal may include a material constituting the first and second plates. The seal 611 may include at least two of a first material, a second material, and a third material. Materials constituting the first and second plates may be fused to each other to provide the seal.

Optionally, at least a portion of at least one of the first plate and the second plate may include a first material. Here, the first material may include iron (Fe). The seal may include the first material and a second material different from the first material. Here, the second material may include chromium (Cr). The second material may include at least two different materials. Here, different materials may include chromium and molybdenum. A weight ratio of the first material may be greater than a weight ratio of the second material. The second material may include a component having greater strength than the first material. Accordingly, it is possible to increase the strength of the seal. The second material may include a component having greater corrosion resistance than the first material. Accordingly, the corrosion resistance of the seal can be improved. The second material may include a component having an oxidation degree greater than that of the first material. Accordingly, the oxidation degree of the second material may be greater than that of the first material. Accordingly, an oxide film having high corrosion resistance can be easily formed. Here, the oxidation degree may be defined as a degree to which an atom, molecule, or ion loses electrons. The melting point of the mixture of the first and second materials may be lower than the melting point of the first material. Accordingly, the mixture can be easily fused during laser welding. The second material may include a portion having a higher melting point than the first material. Accordingly, the second material may not be easily melted during a high-temperature exhaust process. The second material may include a portion having a lower density than that of the first material. Accordingly, the rigidity of the seal can be increased. Accordingly, the flexibility of the seal can be increased.

Optionally, in the mixture of the first and second materials, a weight ratio of the first material may be greater than a weight ratio of the second material. The strength of the second material may be greater than that of the first material. Corrosion resistance of the second material may be greater than that of the first material. The oxidation degree of the second material may be greater than the oxidation degree of the first material. When a plate in which the first and second materials are mixed is provided, the second material first forms an oxide film, and the oxide film of the second material can reduce oxidation of the first material. The melting point of the mixture of the first and second materials may be lower than the melting point of the first material. The melting point of the first material may be lower than the melting point of the second material. The melting points of the mixture of the first and second materials may not be constant. The melting point of the mixture of the first and second materials may be 1400 to 1450 degrees Celsius. The density of the first material may be higher than that of the second material. The price of the first material may be lower than the price of the second material.

Optionally, the oxidation prevention process for suppressing the corrosive oxide film of the seal may include at least one of a first step process, a second step process, and a third step process. Descriptions in any one of the first step process, the second step process, and the third step process may be applied to the other one.

Optionally, the first step process may be performed by coating the surface of the seal with a material having a higher corrosion resistance than the first material. The surface of the seal is fused, and the oxide film of the second material may be damaged. The surface of the seal may be fused and the oxide film of the first material may be exposed. The oxide film of the first material may have weak corrosion resistance. In the first step process, an oxide film made of a material having higher corrosion resistance than the oxide film of the first material may be coated. The oxide film of the second material may have greater corrosion resistance than the oxide film of the first material.

Optionally, the first step process may include at least one of a process in which the weight ratio of the first material decreases and a process in which the weight ratio of the second material increases. Here, the first step process may be performed during the sealing process. While the first material and the second material are mixed again, a weight ratio of the first material to the surface of the seal may increase. While the first material and the second material are mixed again, a weight ratio of the second material on the surface of the seal may decrease. A change in the weight of the seal may result in a decrease in corrosion resistance. In the first step process, corrosion resistance may be increased through readjustment of the weight ratio of the first material and the second material.

Optionally, the first step process may be performed by removing the rough surface of the seal. The rough surface may be generated at the time of fusion. The rough surface can reduce corrosion resistance. The first step process may include sanding the rough surface. The first step process may include a process of lowering the weight ratio of the first material in the seal after sealing. The first step process may include a process of increasing the weight ratio of the second material in the seal after sealing.

Optionally, the first step process may include an electrolytic polishing process. The first step process may include a local electrolytic polishing process. If the entire vacuum adiabatic body is immersed in the electrolyte, side effects may occur due to the electrolyte. For example, the electrolyte may penetrate into the vacuum space. For example, the support may be damaged due to high heat. The local electrolytic polishing process will be described.

Optionally, a first portion that is at least a portion of a portion of the first plate and the second plate excluding the seal on which the sealing is performed may include the first material and the second material. Here, the weight ratio of the second material may be provided as A, and the weight ratio of the second material in the seal may be provided as B. Here, B and A may have different values. The value of B may be greater than that of A. The seal may include a portion having a greater strength than the first portion. Accordingly, the strength of the seal may be increased. The seal may include a portion having greater corrosion resistance than the first portion. Accordingly, the corrosion resistance of the seal may be increased. The seal may include a portion having a greater degree of oxidation than the first portion. Accordingly, it is possible to easily form an oxide film having high corrosion resistance because the degree of oxidation of the seal is high. The seal may include a portion in which an oxide film is formed thicker than the first portion. Accordingly, an oxide film having high corrosion resistance can be easily formed. The seal may include a portion having a lower density than the first portion. Accordingly, the rigidity of the seal may be increased. The seal may include a portion having a higher rigidity than the first portion. Accordingly, the flexibility of the seal may be increased. In the seal, the mixture of the first and second materials may include a portion having a lower melting point than the first portion. Accordingly, the mixture can be easily fused during laser welding. The seal may include a portion having a higher flexibility than the first portion. Accordingly, the flexibility of the seal may be increased. The seal may include a portion having a higher melting point than the first portion. Accordingly, the seal may not be easily melted during a high-temperature drying process. The seal may include a portion in which melting occurs later than the first portion in a high-temperature exhaust process for manufacturing the vacuum adiabatic body. Accordingly, the seal may not be easily melted during a high-temperature exhaust process.

Optionally, the seal may be manufactured by a first step process. The first step process may include a process of coating the second material on the surface of the seal. The first step process may include a process of reducing a weight ratio of the first material in the seal. The first step process may include a process of increasing a weight ratio of the second material in the seal. The first step process may include a process of removing a rough surface from the seal. The first step process may include at least one of the four processes. The first step process may include electrolytic polishing.

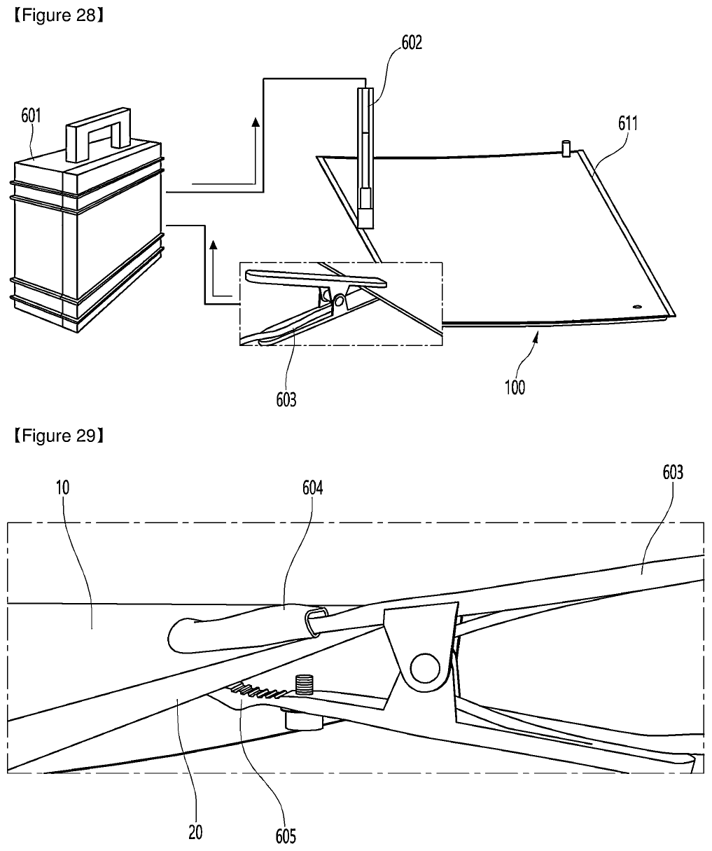

FIG. 28 is a view for explaining the entire process of the local electrolytic polishing process. The local electrolytic polishing process may be performed before the device assembling step (S5). The local electrolytic polishing process may be performed after a high heat treatment process for sealing.

FIG. 28 illustrates a power device 601 that supplies current, a first electrode device 603, and a second electrode device 602. Optionally, the first electrode device may be a negative ground electrode. The second electrode device may be an electrolytic polishing brush. Power specifications of 675 W, 15V, and 45 A are available. The brush of the second electrode device 602 may apply an electrolyte. The second electrode device 602 may move along the seal. Current may flow in the order of the power device 610, the second electrode device 602, and the first electrode device 603. The brush of the second electrode device and the contact portion of the seal 611 may be placed in the electrolyte. The electrolyte may electrolytically polish the surface of the seal 611. The electrolyte may be applied to the seal and adjacent portions. The strength reinforcement portion 11 may prevent the electrolyte from reaching other portions. For example, the tube strength reinforcement portion may prevent the electrolyte from flowing into the vacuum space 50.

FIG. 29 is a perspective view illustrating the connection between the first electrode device and the vacuum adiabatic body.

Referring to FIG. 29, optionally, the first electrode device may have tongs. Since a high current is applied, a discharge phenomenon may occur in the contact portion between the first electrode device 603 and the vacuum adiabatic body 100. The discharge phenomenon may damage the surface of the vacuum adiabatic body 100. An adiabatic pad 604 may be provided at a portion of the first electrode device 603 in contact with the first plate. The adiabatic pad 604 may protect the tongs. A high voltage discharge may not occur in the contact portion between the first plate and the first electrode device. The first plate may not be damaged. A conductive pad 605 may be provided at a portion of the first electrode device 603 in contact with the second plate. A high voltage discharge may occur in a contact portion between the second plate and the first electrode device. Since the second plate has a predetermined thickness, the second plate may not be damaged.

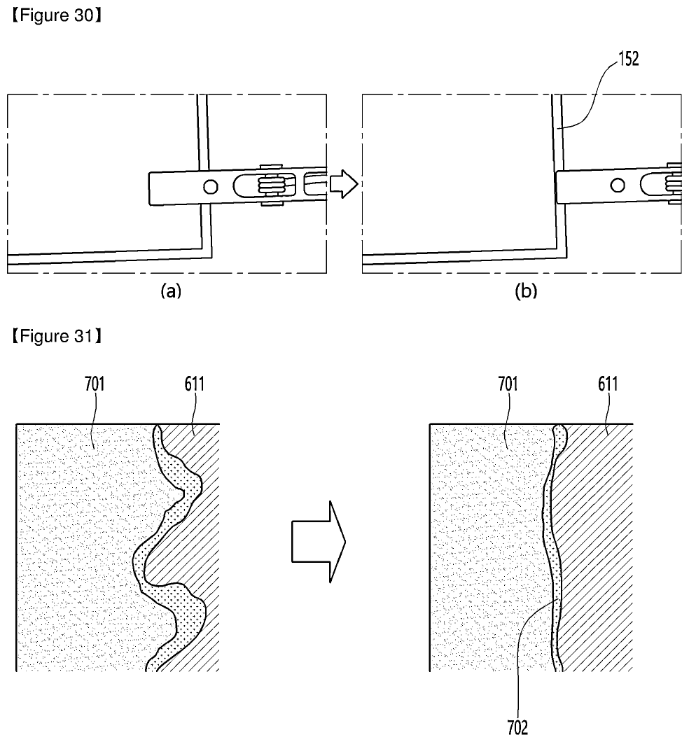

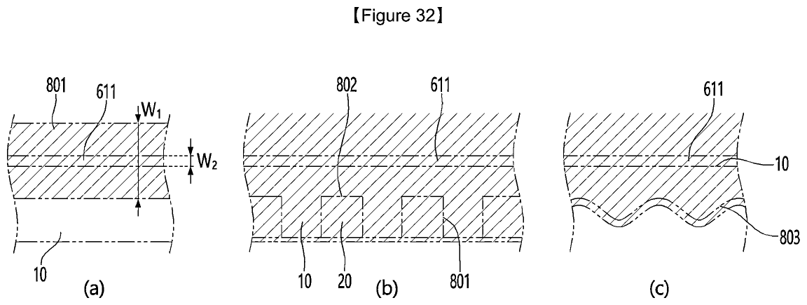

FIG. 30 is a plan view illustrating the connection between the first electrode device and the vacuum adiabatic body. It will be described with reference to FIG. 30. The discharge phenomenon may occur a lot at the end of the first electrode device 603. Optionally, the first electrode device 603 may contact the outside of the seal 611. The first electrode device 603 may be in contact with the second portion 152 of the side plate. Even if the discharge phenomenon occurs, at least the inside of the seal may not be affected. In the case of FIG. 32(a), even if the adiabatic pad 604 is provided, a perforation may occur in the first plate by discharge. It may be preferable that the application portion is also provided on the outside of the seal as illustrated in FIG. 32(b).

The second electrode device 602 may move at a constant speed. The second electrode device 602 may move at a speed of approximately 60 centimeters per minute. The brush portion of the second electrode device 602 may move on the upper surface of the seal 611. The second electrode device 602 may apply an electrolyte and/or conduct current. An electrolytic polishing operation may occur in the seal by the applied current and the electrolyte.

FIG. 31 is a view for explaining the electrolytic polishing operation. It will be described with reference to FIG. 31. FIG. 31(b) illustrates the seal before the electrolytic polishing operation. Referring to FIG. 31(a), an oxide film may optionally be formed on the surface of the seal 611. The oxide film may be in a state where the oxide film of the second material is damaged. In the oxide film, the weight ratio of the first material may increase when the first and second materials are remixed. The oxide film may have irregularities. The oxide film of the seal may have weak corrosion resistance before electrolytic polishing.

With the electrolyte 701 in contact with the oxide film, a current may flow from the seal 611 to the electrolyte. By this operation, the electrolytic polishing operation can be performed. The seal may form a passivation film by the electrolytic polishing operation. A dense structure of a chromium oxide film may be formed in the seal by the electrolytic polishing operation. FIG. 31(b) illustrates the seal according to the result of the electrolytic polishing operation. Referring to FIG. 31(b), the oxide film may return to the oxide film of the second material. The oxide film may return to a state where the weight ratio of the second material among the first and second materials is high. The unevenness of the oxide film may be removed to make it planarized. After the local electrolytic polishing process is finished, it can be washed. The electrolyte has strong corrosiveness. The place where the electrolyte is attached so that the electrolyte is not left can be washed with water for 30 seconds or more. After the electrolytic polishing process, corrosion resistance of the seal may be improved. After the first step process, the reliability of the vacuum adiabatic body may be improved. After the first step process, the life of the vacuum adiabatic body may be extended.

Optionally, the second step process may be performed on the seal. The second step process may be performed after the seal is provided. The second step process may be performed after the first step process. The second step process may be performed before the third step process. The second step process may include a process of applying a mixture to prevent moisture penetration into the seal. The moisture may include brine. As the mixture, an insulating coating agent (first mixture) of a silicone component may be used. As the silicone-based insulating coating agent, Navachem's S-830 can be used. The mixture may use a metal component anti-rust coating agent (second mixture). The metal component anti-rust coating agent Navachem L-316 can be used.

Table 1 and Table 2 are views illustrating the components of the insulating coating agent of the silicone component and the rust prevention coating agent of the metal component, respectively.

TABLE 1

| Chemical substance | Another | CAS number/ | |
|---|---|---|---|
| name | name | identification number | Content(%) |
| Unknown modified | No data | trade secret | 20~30 |
| Silicone polymer | | | |
| Toluene | Methylbenzene | 108-88-3 | 15~25 |
| Xylene | Dimethylbenzene | 1330-20-7 | 1~10 |
| Ethyl benzene | Ethylbenzene | 100-41-4 | 1~10 |
| Acetone | 2-propanone | 67-64-1 | 5~15 |
| Dimethyl ether | Methyl ether | 115-10-6 | 25~35 |

TABLE 2

| Chemical | Common name and | CAS number/ | |
|---|---|---|---|
| substance name | Another name | identification number | Content(%) |
| Metal | No data | 7439-89-6 | 0.01~0.1 |
| powder(SUS, | MOLYBDATE | 7439-98-7 | 1~5 |
| Al) iron | No data | 7429-90-5 | 1~10 |
| Molybdenum | No data | 7440-02-0 | 0.1~0.5 |
| Aluminium | | | |
| Nickel | | | |
| Toluene | Methylbenzene | 108-88-3 | 20~30 |
| Xylene | Dimethylbenzene | 1330-20-7 | 1~10 |
| Modified | 4,4-(1- | 25068-38-6 | 10~20 |
| epoxy | methylethylidene)bisphenol | | |
| resin | polymer with | | |
| | (chloromethyl)oxirane | | |
| Silica | Reaction product with | 68611-44-9 | 0.1~1 |
| | Dimethyldichlorosilane, | | |
| | silica | | |
| | Methyl ether | 115-10-6 | 35~45 |

As a composition of the first and second mixtures, optionally, the composition may include at least one of an adhesive component, a solvent, a moisture permeation preventing component, an adhesive strength improving component, a corrosion resistance improving component, and a spraying component.

Optionally, as the adhesive component, the modified silicone polymer may play a weak role. The modified epoxy resin may play a weak role. The adhesive component may enable the composition to be attached to the seal together with application.

Optionally, as the solvent, toluene, xylene, and acetone may play a role.

Optionally, as the moisture permeation prevention component, the modified silicone polymer may play a strong role. The modified epoxy resin may play a weak role. The metal powder may play a strong role. The metal powder may include at least one component of iron, molybdenum, aluminum, and nickel.

Optionally, as the adhesive strength improving component, the modified silicone polymer may play a strong role.

Optionally, as the corrosion resistance improving component, the metal powder may play a role.

Optionally, as the spraying component, dimethyl ether may be used. The spraying component may reduce the viscosity of the mixture. The spraying component may allow the mixture to penetrate well into cracks in the weld. Through this, the performance of the weld can be improved. Conversely, if the viscosity is too small, the plate surface may have weak adhesion. Optionally, the viscosity of the mixture may range from 1 cs (centistokes)≤the viscosity of the mixture≤10 cs (centistokes).

Optionally, the mixture may be applied to the seal. FIG. 32 is a partial plan view of a vacuum adiabatic body illustrating a second step process of applying the mixture. See FIG. 32(a). Optionally, an application portion 801 may be provided to cover the seal 611. In the drawing, the application portion is indicated by hatching. The application portion may cover the entire seal. The application portion may extend along the seal. The thickness of the application portion may be thicker than that of the first plate. The thickness of the application portion may be thinner than that of the second plate. The width W1 of the application portion may be greater than 5 times the width W2 of the seal. The width W1 of the application portion may be smaller than the width of the second portion 152 of the side plate. The second portion of the side plate may refer to an area in which the side plate and the first plate face each other. See FIG. 32(b). A cutout 802 in which at least a portion of the first plate or the side plate is cut may be provided. The application portion 801 may cover at least a portion of the cutout. The application portion may be provided after the cutout is provided. The mixture can attach the first plate and the side plate to a wider length. The application portion 801 may cover at least a portion of an upper surface of a portion where the first plate and the side plate are spaced apart. The application portion 801 may cover at least a portion of a side gap of portion in which the first plate and the side plate are spaced apart from each other. The application portion 801 may be inserted into at least a portion of a gap in which the first plate and the side plate are spaced apart from each other. The application portion 801 may extend to at least a portion of a lower surface of the side plate. See FIG. 32(c). A cutting portion 803 in which the first plate and the side plate are cut together may be provided. The application portion 801 may be provided by covering the edge of the cutting portion. Even in this case, various embodiments of the above application portion may be applied. The application portion may be used in any case of the first and second mixtures.

Optionally, a first portion that is at least a portion of a portion of the first plate and the second plate excluding the seal on which the sealing is performed may include the first material and the second material. The seal may include a material A different from the first material and the second material. Here, material A may include S-830 coating agent or L-316 coating agent. The seal may include a portion having a greater strength than the first portion. Accordingly, the strength of the seal may be increased. The seal may include a portion having greater corrosion resistance than the first portion. Accordingly, the corrosion resistance of the seal may be increased. The seal may include a portion having a higher adhesive strength or viscosity than the first portion. Accordingly, the adhesiveness of a seal can be improved. The seal may include a portion having a higher moisture permeability prevention degree than the first portion. Accordingly, the moisture permeability prevention degree of the seal can be improved. The seal may include a portion having a higher waterproof ability than the first portion. Accordingly, the waterproof ability of the seal can be improved. The material A may include an insulating coating agent of a silicone component. The material A may include a metal component anti-rust coating agent. The material A may include metal powder. The material A may include a material satisfying 1 cs (centistokes)≤the viscosity of material A≤10 cs (centistokes). The material A may include at least one of the four materials.

Optionally, the seal may be manufactured by a second step process. Here, the second step process may include a process of coating a surface of the seal with a material A different from the first material and the second material. Here, the second step process may include a process in which the weight ratio of the first material and the second material in the seal is reduced. Here, the second step process may include a process of increasing the weight ratio of the material A in the seal. Here, the second step process may include at least one of a process of removing a rough surface from the seal. Here, the second step process may include a process of providing an application portion to the seal.

Optionally, the third step process may be performed on the seal. The third step process may be performed after the second step process. After performing at least one of the first step process and the second step process, the third step process was performed. The third step process may be a post-processing process for the application portion 801. The third step process may include at least one condition of initial humidity (for example, during application), dry humidity (for example, during drying), and time after the application unit 801 is provided. A cross-cut experiment was performed under different post-processing conditions for the application portion 801. The cross-cut experiment may be performed by providing 10 grids having 1 millimeter gap with 1 cm in length in the left and right direction after the post-processing, and attaching and detaching a standard tape to the grid. Each line of the grid can be provided by marking with a knife. It can be determined that the performance of the application portion is poor as the amount of peeling of the application portion 801 in the inner area of the grid increases. Table 3 below is a view summarizing the results of the cross-cut experiment.

TABLE 3

| | Dry | Initial | Drying | | | | | Success |
|---|---|---|---|---|---|---|---|---|
| | humidity | humidity | time | | #1 | #2 | #3 | rate |
| 1 | 60% | 60% | 48 | h | P | P | P | 100% |
| 2 | 60% | 60% | 24 | h | P | P | P | 100% |
| 3 | 60% | 60% | 6 | h | F | P | P | 66% |
| 4 | 60% | 87% | 48 | h | F | P | P | 66% |
| 5 | 60% | 87% | 24 | h | P | F | P | 66% |
| 6 | 60% | 87% | 6 | h | F | P | F | 33% |
| 7 | 87% | 60% | 48 | h | P | F | F | 33% |
| 8 | 87% | 60% | 24 | h | F | F | P | 33% |
| 9 | 87% | 60% | 6 | h | F | F | F | 0% |
| 10 | 87% | 87% | 24 | h | F | F | F | 0% |
| 11 | 87% | 87% | 6 | h | F | F | F | 0% |
| 12 | 90% | 60% | 24 | h | F | F | F | 0% |
| 13 | 90% | 60% | 6 | h | F | F | F | 0% |
| 14 | 90% | 87% | 24 | h | F | F | F | 0% |
| 15 | 90% | 87% | 6 | h | F | F | F | 0% |

Referring to Table 3, P means pass and F means fail. According to the results of the experiment, it may be preferable that the drying humidity is lowered. Optionally, the pass may be possible when the dry humidity is 87% or less. If the initial humidity is 87% or less, the pass may be possible. When the initial humidity is 87% or less, if the drying time is within the range of 6 hours to 48 hours, in any case, the pass may be possible.

Optionally, the dry humidity is preferably 60% or less. When the dry humidity is 60% or less, if the initial humidity is 87% or less, it is preferable at any time. When the drying humidity is 60% or less, if the drying time is in the range of 6 hours to 48 hours, it is preferable at any time.

Optionally, the seal may be manufactured by a third step process. The third step process may include a process in which the seal or the vicinity of the seal is dried. The third step process may include a process in which the seal or the vicinity of the seal is stored within a predetermined humidity range. The third step process may include at least one of the two processes. The predetermined humidity condition may satisfy at least one of a dry humidity of 87% or less and an initial humidity of 87% or less. The predetermined humidity condition may satisfy at least one of a dry humidity of 87% or less and an initial humidity of 60% or less. The predetermined humidity condition may satisfy at least one of a dry humidity of 60% or less and an initial humidity of 87% or less. The predetermined humidity condition may satisfy at least one of a dry humidity of 60% or less and an initial humidity of 60% or less. The third step process may include a process of being maintained for 6 hours or more. The third step process may include a process of being maintained for 24 hours or more. The third step process may include a process of being maintained for 48 hours or more. In the third step process, when a is defined as any one of dry humidity and initial humidity, and b is defined as the storage time, the first ab relational expression may satisfy a/b≤14.5 (%/hr). Here, the first ab relational expression may satisfy a/b≤10 (%/hr). Here, the first ab relational expression may satisfy a/b≤7.25 (%/hr). In the third step process, when a is defined as any one of dry humidity and initial humidity, and b is defined as the drying time, the second ab relational expression may satisfy a/b≤14.5 (%/hr). Here, the second ab relational expression may satisfy the above a/b≤10 (%/hr). Here, the second ab relational expression may satisfy a/b≤7.25 (%/hr).

Optionally, the seal is manufactured by at least two or more processes, and the process may include a process A and a process B. The process A may include at least one of fusion welding and pressure welding. The process B may include at least one of a first step process, a second step process, and a third step process. In the process B, at least two or more of the first step process, the second step process, and the third step process may be simultaneously performed. The first step process includes a process of increasing the strength of the seal, a process of increasing the corrosion resistance of the seal, a process of increasing the oxidation degree of the seal, a process of forming a thicker oxide film on the seal, a process of reducing the density of the seal, a process of increasing the rigidity of the seal, a process of increasing the flexibility of the seal, a process of raising or lowering the melting point of the seal, in the high-temperature exhaust process for manufacturing the vacuum adiabatic body, a process in which the melting of the seal occurs late, a process of changing a weight ratio of a composition constituting a material of the seal, a process of coating the seal; and a process of changing the formation of the surface of the seal. The second step process may include at least one of a process of increasing the strength of the seal, a process of increasing the corrosion resistance of the seal, a process of increasing the adhesive strength or viscosity prevention degree of the seal, a process of increasing the moisture permeability of the seal, a process of increasing the waterproofing ability of the seal, a process of changing the weight ratio of a composition constituting the material of the seal, a process of coating the seal, and a process of changing the formation of the surface of the seal may include The third step process may include at least one of a process in which the seal or the vicinity of the seal is dried, and a process in which the seal or the vicinity of the seal is stored within a predetermined humidity range. The process B may be performed after the process A is performed. The process B may be performed while the process A is being performed.

### INDUSTRIAL APPLICABILITY

According to the present disclosure, it is possible to provide a vacuum adiabatic body that can be applied to real life.

1. A vacuum adiabatic body comprising:
a first plate;
a second plate;
a vacuum space disposed between the first plate and the second plate, and configured to be provided in a vacuum state; and
a seal configured to seal the first plate and the second plate and form the vacuum space, wherein the seal has improved corrosion resistance.

2. The vacuum adiabatic body of claim 1,
wherein the corrosion resistance is improved after the seal seals the first plate and the second plate, and
wherein the seal includes at least two of a first material, a second material, and a third material.

3. The vacuum adiabatic body of claim 2,
wherein a weight ratio of the first material is greater than a weight ratio of the second material,
wherein a strength of the second material is greater than a strength of the first material,
wherein a corrosion resistance of the second material is greater than a corrosion resistance of the first material,
wherein a degree of oxidation of the second material is greater than a degree of oxidation of the first material,
wherein a melting point of a mixture of the first and second materials is lower than a melting point of the first material, and the melting point of the first material is lower than a melting point of the second material.

4. The vacuum adiabatic body of claim 1,
wherein the seal includes at least two of a first material, a second material, and a third material, and
wherein the seal is formed by at least one of a first process, a second process, and a third process in order to improve corrosion resistance.

5. The vacuum adiabatic body of claim 4,
wherein the first process includes at least one of:
coating a surface of the seal with a material having higher corrosion resistance than the first material,
a process in which a weight ratio of the first material decreases, and a process in which a weight ratio of the second material increases, and
removing a rough surface of the seal.

6. The vacuum adiabatic body of claim 4,
wherein the first process includes electrolytic polishing.

7. The vacuum adiabatic body of claim 1,
wherein the seal is formed by at least one of a first process, a second process, and a third process to improve corrosion resistance, and
wherein the second process is performed after the seal is sealed.

8. The vacuum adiabatic body of claim 7,
wherein the second process is performed after the first process.

9. The vacuum adiabatic body of claim 7,
wherein the second process is performed before the third process.

10. The vacuum adiabatic body of claim 7,
wherein the second process includes applying a composition to the seal to provide an application portion.

11. The vacuum adiabatic body of claim 10,
wherein the composition is an insulating coating agent of a silicone component or an antirust coating agent of a metal component, and
wherein metal powder is included in the composition, or viscosity of the composition is 1 cs (centistokes)≤viscosity of the mixture≤10 cs (centistokes).

12. The vacuum adiabatic body of claim 10,
wherein the application portion is to cover the seal,
wherein the application portion covers the entire seal,
wherein the application portion extends along the seal,
wherein a thickness of the application portion is thicker than the first plate,
wherein the thickness of the application portion is thinner than the second plate,
wherein a width of the application portion is greater than 5 times a width of the seal,
wherein the width of the application portion is smaller than a width of a second portion of a side plate,
wherein the application portion covers at least a portion of a cutout in which at least one of the first and second plates is cut,
wherein the application portion covers at least a portion of an upper surface of a portion obtained by the first plate spaced apart from the second plate,
wherein the application portion covers at least a portion of a side gap of the portion obtained by the first plate spaced apart from the side plate,
wherein the application portion is inserted into at least a portion of the gap obtained by the first plate spaced apart from the side plate,
wherein the application portion extends to at least a portion of a lower surface of the side plate, or
wherein the application portion covers a cutting portion in which the first plate and the side plate are cut.

13. The vacuum adiabatic body of claim 7,
wherein the third process is performed after performing at least one of the first process and the second process,
wherein the third process includes:
dry humidity is 87% or less,
initial humidity is 87% or less,
initial humidity is 87% or less and drying time is within a range of 6 hours to 48 hours,
dry humidity is 60% or less,
dry humidity is 60% or less and an initial humidity is 87% or less, or
drying humidity is 60% or less and drying time is within a range of 6 hours to 48 hours.

14. A method for manufacturing a vacuum adiabatic body to have a seal that seals a first plate and a second plate to provide a vacuum space between the first plate and the second plate, comprising:
manufacturing a component to be applied to the vacuum adiabatic body;
assembling the component;
sealing an outer wall of the vacuum space to block the vacuum space from an external space;
exhausting internal air of the vacuum space; and
providing a device configured to use the vacuum adiabatic body;
wherein improving corrosion resistance of the seal is performed before the providing of the device.

15. The method for manufacturing a vacuum adiabatic body of claim 14,
wherein the seal includes at least two of a first material, a second material, and a third material, and
wherein the seal is formed by at least one of a first process, a second process, and a third process in order to improve corrosion resistance.

16. An apparatus for manufacturing a vacuum adiabatic body to have a seal that seals a first plate and a second plate to provide a vacuum space between the first plate and the second plate, comprising:
a power device that supplies current;
a first electrode device coupled to the power device and configured to supply power and electrolyte to the vacuum adiabatic body; and
a second electrode device indirectly coupled to the first electrode device through the vacuum adiabatic body and is coupled to the power device.

17. The apparatus for manufacturing a vacuum adiabatic body of claim 16,
wherein the first electrode device supplies the electrolyte to the seal.

18. The apparatus for manufacturing a vacuum adiabatic body of claim 16,
wherein the first electrode device includes a brush configured to supply the electrolyte.

19. The apparatus for manufacturing a vacuum adiabatic body of claim 16,
wherein the second electrode device is in contact with outside of the seal.

20. The apparatus for manufacturing a vacuum adiabatic body of claim 16,
wherein an adiabatic pad is provided at the second electrode device.
